(19) United States
(12) Patent Application Publication
(10) Pub. No.: US 2003/0130945 A1
(43) Pub. Date: Jul. 10, 2003

(54) Electronic transaction processing server with trend based automated transaction evaluation

(75) Inventors: Michael Patrick Force, Lake Villa, IL (US); Lisa Christine Batur, Fort Myers, FL (US); Eric Campbell, Rye, NH (US)

Correspondence Address: TIMOTHY P. O'HAGAN, 8710 KILKENNY CT, FORT MYERS, FL, 33912, US

(73) Assignee: Bottomline Technologies (DE) Inc., Portsmouth, NH

(21) Appl. No.: 10/321,334

(22) Filed: Dec. 17, 2002

Related U.S. Application Data
(63) Continuation-in-part of application No. 10/232,162, filed on Aug. 30, 2002.
(63) Continuation-in-part of application No. 10/139,596, filed on May 6, 2002.
(63) Continuation-in-part of application No. 10/041,513, filed on Jan. 8, 2002.
(63) Continuation-in-part of application No. 10/260,887, filed on Sep. 30, 2002.

(51) Int. Cl. G06F 17/60

(52) U.S. Cl. 705/40

(57) ABSTRACT

An automated invoice management system includes a network circuit for communicating over a frame switched network with each of the plurality of participating systems. A transaction management engine comprises means for establishing a secure session with a receiving system and with a first participating system through the network circuit, means for receiving an evaluation parameter set from the receiving system, means for receiving an import electronic transaction file from the first participating system, and means for providing an export electronic transaction file to the receiving system. The export file comprises the plurality of data element values and comprises an message that corresponds to a result of an evaluation engine calculating the result of applying the evaluation parameter to the data element values.

### CROSS REFERENCE TO RELATED APPLICATIONS

The present application is a continuation in part of U.S. patent application Ser. No. 10/260,887, entitled Electronic Transaction Processing Server with Automated Transaction Evaluation, filed on Sep. 30, 2002; is a continuation in part of U.S. patent application Ser. No. 10/232,162, entitled Electronic Invoice Processing System with Boolean Rules Feature filed on Aug. 30, 2002; is a continuation in part of U.S. patent application Ser. No. 10/139,596 entitled Automated Invoice Receipt and Management System with Automated Loading Systems filed on May 6, 2002; and is a continuation in part of U.S. patent application Ser. No. 10/041,513 entitled Automated Invoice Receipt and Management System with Field Value Substitution filed on Jan. 8, 2002.

### TECHNICAL FIELD

The present invention relates to a financial transaction management system, and more particularly, to a network-based transaction management system that provides an automated analysis of transaction data based on trends of previous transaction data.

### BACKGROUND OF THE INVENTION

Typically a business will have an accounting software system that maintains a database of the business transactions with its customer, vendors, banks, and other third parties associated with the business as well as internal business transactions between internal accounts. The typical architecture of such accounting systems provides for data to be input into the system through predefined transactions. The system then updates applicable records in the database.

For example, when an invoice is received from a vendor, an accounts payable employee will typically open a manual data entry (MDE) screen or panel which prompts the employee to enter each element of data from the invoice and then submit the entered data to the application as a single invoice transaction. At that time the system will write the newly entered invoice transaction into the database. Other transactions such as requests for quotation, purchase orders, sales orders, shipping, payment and remittance, and etc, are entered in a similar manner.

To assure that all necessary transaction data is complete, the application will not accept the transaction and update the applicable records in the database until all required fields have been entered and the data is validated.

While these accounting systems facilitate record keeping and may reduce data entry for internal transactions, transactions between business have traditionally been handled by one businesses software system printing a transaction document and the other business manually entering the transaction into their system using data from the document.

To facilitate the exchange of transaction documents electronically, in 1979 the American National Standards Institute (ANSI) charted the Accredited Standards Committee (ASC) to develop and maintain a standard for Electronic Data Interchange (EDI) of business transaction documents.

The ANSI ASC X12 “standards” are essentially a uniform syntax for packaging ASCII data elements that comprise a business transaction. The syntax applies a lightly-structured set of labels and positional rules, and a looping structure, on ordinary ASCII characters. Information can be coded in X12 on one accounting system and transmitted to the recipient using floppy diskette, magnetic tape, Internet, or any type of real-time or batch or communication system to a recipient system's X12 interpreter.

Each transaction set is roughly equivalent to a generic “type” of business paper document, such as an invoice, request for quotation, purchase order, sales order, shipping document, payment and remittance document. A three-digit number, called a standard-development track number, is used to identify each type of electronic document. As an example, a purchase order has a standard-development track number of 850, the invoice is an 810, and a request for quotation is an 840.

Each type of transaction set, in turn, is made up of a series of data elements or “segments”—each roughly equivalent to a “line”, “block”, or “field” of related data on a paper form. A segment code name is used to identify a logical and predefined combination of related data elements. For example, a segment code “DTM” specifies that “date-and-time” usually has three related data elements. The first data element would contain a code number or character indicating the kind of date to follow, such as shipping date, invoice date, publication date, or other pre-specified date. The second data element would contain the date itself, using six digits, and the third data element would be the time of day. Special characters separate data elements within the segment and mark the termination of a segment and the beginning of the next segment.

Another example of a segment might be the “PER” segment that represents the name and telephone number of the “person to contact” which is coded in X12 as:

PER*1C*W. M. Smith*TE*6035551234*\

where “PER” is the identifier for the segment, and “1C” and “TE” are the reference codes for person name (W. M. Smith) and phone number (6035551234). “\” signifies end of segment.

The data element dictionary provides definitions for the individual elements of data which are assembled to compose each segment of information within the electronic transaction.

The data element dictionary defines the data elements that can be transmitted and provides a standard identifying code for each element. Data elements are the X12 “atoms”, the basic building blocks of the record being transmitted. Additionally, the X12 dictionary contains tables of predefined code values for commonly encountered items of business data. An example of data elements often found together are the telephone number of a point of contact; the X12 reference code is “TE,” which when encountered tells the receiver that the following data item (e.g. “603-555-1212”) should be interpreted as a telephone number rather than a fax or pager number. The value “TE” is an example of a standard, predefined X12 code value, and the phone number itself is an example of a user-supplied value. The X12 standards provide a powerful combination of predictable positions—or data “pigeonholes”—in which to place or find both kinds of elements of data.

In theory, an electronic transaction that is constructed using the X12 standards should be easily interpreted by a recipient system utilizing an X12 translator. However, as a practical matter, there is no true single standard governing the format of a transaction. Instead, there are multiple data dictionaries defining transaction formats, with multiple versions which proliferate the business world, both domestically and globally.

The X12 documents sets discussed above have been periodically revised and not all systems properly interpret each revision. As of the year 1999, at least 13 different versions of X12 were in existence (version 2000 through version 4030). In addition to the X12 revisions, other electronic transaction formats include UN/EDIFACT (United Nations rules for Electronic Data Interchange For Administration, Commerce and Transport), CEFACT (Centre for Facilitation of Procedures and Practices for Administration, Commerce and Transport), NACHA (National Automated Clearinghouse Association), and SWIFT (Society for Worldwide Interbank Financial Telecommunications). Further, each of these data dictionaries is periodically updated and a new version is issued. The updates may include new “codes”, or entries, to the data dictionary, the deletion of codes, as well as modifications of existing codes.

Therefore, from a practical standpoint, only large companies that exert substantial leverage over their trading partners can truly realize the efficiencies of EDI by using a single standard (e.g. their standard) while all of their trading partners conform to their standards.

If a company can not leverage its trading partners to use EDI in their standard, EDI is not likely to provide any cost savings as the multiple number of standards that would need to be maintained would likely cost more than data entry. For example, if a company without adequate leverage to provide for all of its suppliers to use a single EDI standard for sending invoices to the company, the company would have to maintain multiple dictionaries on its system and still be required to maintain a manual data entry department for those suppliers that do not use any form of EDI. Such costs would defeat any cost savings of receiving a portion of the invoices electronically.

Further, if a company can gain efficiencies of EDI for exchanging electronic transactions with its trading partners, the efficiencies are limited to reducing operator data input. The approval and payment process still lacks automation. For example, an invoice transaction may be reviewed and approved by personnel at several approval levels before the customer's accounts payable person enters a payment transaction to initiate a remittance transaction to the vendor.

In an effort to gain efficiencies in an invoice approval process, some systems have automated routing wherein an electronic version of the invoice transaction is sequentially stored in an approval queue for each of the people who must approve the invoice. Such automated routing systems may even evaluate the invoice total and other invoice fields to determine which people, and at what corporate approval levels, are required to approve the invoice before payment. Invoices with a total below a predetermined threshold may even be routed to an accounts payable person for payment with minimal or no manual approval.

Even with auto-routing, the process of evaluating business impact of the invoice information remains a manual task. Each person within the approval process may evaluate how the invoice information, as it relates to information of previous invoices, impacts the business and/or the relationship with the vendor.

What is needed is an electronic document management system that can accept electronic transactions from a plurality of system participants using a plurality of electronic formats, manage and normalize the transaction data, provide each transaction to its intended recipient in an electronic data structure that is compatible with the recipients accounting system, and can evaluate the transaction data in accordance with evaluation parameter sets input by the recipient and supply evaluation information to the recipient in conjunction with the transaction.

### SUMMARY OF THE INVENTION

A first aspect of the present invention is to provide an electronic transaction processing server for exchanging electronic transaction files between a plurality of participating systems. The server comprises a database for storing data representative of a plurality of transactions between the participating systems and for storing a plurality of evaluation parameters. A network circuit communicates over a frame switched network with each of the plurality of participating systems. The server includes a transaction management engine which comprises: i) means for establishing a secure session with each of a receiving system and a first participating system through the network circuit; ii) means for receiving a first evaluation parameter set from the receiving system; iii) means for storing the evaluation parameter set in the database; iv) means for receiving an import electronic transaction file from a first participating system; v) means for providing an export electronic transaction file to a receiving system; vi) an evaluation engine; and vii) a translation engine.

The first evaluation parameter set may comprise identification of a first plurality of reference transactions stored in the database, identification of at least one data point value within each of the first plurality of reference transactions, and identification of a first evaluation threshold.

The import transaction file may comprise a plurality of transaction data element values in a file format that complies with a first import file definition and at least one of which is a first key element value.

The export electronic transaction file may comprise a plurality of data element values in a file format that complies with a receiving system file definition and comprises an evaluation message.

The evaluation engine provides for selecting one of a plurality of evaluation messages for inclusion in the export electronic transaction file by: i) calculating a first threshold value by applying the first threshold evaluation function to each data point value from each of the first plurality of reference transactions; ii) determining a first true/false result by comparing the first key element value to the first threshold value; and iii) selecting the one of the plurality of evaluation messages the corresponds to the first true/false function result; and iv) writing an indication of the selected one of the plurality of predefined messages to the database,

The translation engine may comprise: i) means for translating the plurality of data element values of the import electronic transaction file to a plurality of normalized data element values complying with a normalized file definition; ii) means for storing the plurality of normalized data element values in a transaction database; and iii) means for generating at least a portion of the export electronic transaction file by translating the plurality of normalized data element values to a plurality of export data element values complying with the receiving system file definition.

The selected one of the predefined messages may further comprise a resultant value. In which case, the transaction management engine may further comprise means for receiving a quantitative evaluation function and the evaluation engine may further comprises means for calculating a resultant value by calculating the result of applying the quantitative evaluation function to each data point value from each of the plurality of reference transactions.

In a sub embodiment, the transaction management engine may further comprise means for receiving a second evaluation parameter set and a Boolean operator, for relating the first true/false function result to a second true/false function result, from the receiving system. The second evaluation parameter set may comprise: i) identification of a second plurality of reference transactions stored in the database; ii) identification of at least one data point value within each of the second plurality of reference transactions; and iii) identification of a second evaluation threshold.

In such sub embodiment, the evaluation engine may further comprise means for calculating the result of applying the second evaluation parameter to the second key element value by: i) calculating a second threshold value by applying the second threshold evaluation function to each data point value from each of the second plurality of reference transactions; ii) determining a second true/false result by comparing the second key element value to the second threshold value; iii) determining a Boolean true/false result by comparing, using the Boolean operator, the first true/false function result to the second true/false function result; and iv) the step of selecting one of the plurality of evaluation messages comprises selecting the one of the plurality of evaluation messages that corresponds to the Boolean true/false result.

A second aspect of the present invention is to provide a method of processing electronic transactions between a plurality of participating systems. The method comprises: i) establishing a secure session with a receiving system over a frame switched network; ii) establishing a secure session with a first participating system over a frame switched network; iii) receiving a first evaluation parameter set from the receiving system which may include identification of a first plurality of reference transactions stored in a database, identification of at least one data point value within each of the first plurality of reference transactions, and identification of a first evaluation threshold; iv) storing the evaluation parameter set in a database; v) receiving an import electronic transaction file from the first participating system that includes plurality of transaction data element values in a file format that complies with a first import file definition and at least one of the transaction data element values being a first key element value; v) calculating a first threshold value by applying the first threshold evaluation function to each data point value from each of the first plurality of reference transactions; vi) determining a first true/false result by comparing the first key element value to the first threshold value; vii) selecting an evaluation message from one of a plurality of evaluation messages the corresponds to the first true/false function result; ix) writing an indication of the selected evaluation message to the database; and viii) providing an export electronic transaction file to the receiving system which may include the plurality of transaction data element values in a file format that complies with a receiving system file definition and comprises the evaluation message.

The method may further comprise: i) translating the plurality of data element values of the import electronic transaction file to a plurality of normalized data element values complying with a normalized file definition; ii) storing the plurality of normalized data element values in a transaction database; and iii) generating at least a portion of the export electronic transaction file by translating the plurality of normalized data element values to a plurality of export data element values complying with the receiving system file definition.

The selected evaluation message may further comprise a resultant value. In which case, the method may further comprise receiving a quantitative evaluation function and calculating a resultant value by calculating the result of applying the quantitative evaluation function to each data point value from each of the plurality of reference transactions.

In a sub embodiment, the method may further comprise receiving a second evaluation parameter set and a Boolean operator from the receiving system, the second evaluation parameter set including identification of a second plurality of reference transactions stored in the database, identification of at least one data point value within each of the second plurality of reference transactions, and identification of a second evaluation threshold, and calculating the result of applying the second evaluation parameter to the second key element value. Calculating the result of applying the second evaluation parameter to the second key element value may comprise: i) calculating a second threshold value by applying the second threshold evaluation function to each data point value from each of the second plurality of reference transactions; ii) determining a second true/false result by comparing the second key element value to the second threshold value; iii) determining a Boolean true/false result by comparing, using the Boolean operator, the first true/false function result to the second true/false function result; and iv) the step of selecting one of the plurality of evaluation messages comprises selecting the one of the plurality of evaluation messages that corresponds to the Boolean true/false result.

For a better understanding of the present invention, together with other and further aspects thereof, reference is made to the following description, taken in conjunction with the accompanying drawings. The scope of the invention is set forth in the appended claims.

### BRIEF DESCRIPTION OF THE DRAWINGS

FIG. 1 is a block diagram of an automated invoice and remittance transaction management architecture in accordance with one embodiment of the present invention;

FIG. 2 is a block diagram of an automated invoice and remittance transaction management system in accordance with one embodiments of the present invention;

FIG. 3a is a table diagram representing column names in an exemplary invoice and remittance database table in accordance with one embodiment of the present invention;

FIG. 3b is a table diagram representing column names in an exemplary invoice and remittance database table in accordance with one embodiment of the present invention;

FIG. 3c is a table diagram representing column names in an exemplary invoice and remittance database table in accordance with one embodiment of the present invention;

FIG. 3d is a table diagram representing column names in an exemplary invoice and remittance database table in accordance with one embodiment of the present invention;

FIG. 3e is a table diagram representing column names in an exemplary invoice and remittance database table in accordance with one embodiment of the present invention;

FIG. 4a is a table diagram representing column names in an exemplary value set database table in accordance with one embodiment of the present invention;

FIG. 4b is a table diagram representing column names in an exemplary values set database table in accordance with one embodiment of the present invention;

FIG. 5 is a table diagram representing an exemplary rules table in accordance with one embodiment of the present invention;

FIG. 6 is a flow chart representing an exemplary workflow script in accordance with one embodiment of the present invention;

FIG. 7 is a flow chart representing an exemplary workflow script in accordance with one embodiment of the present invention;

FIG. 8a is a table diagram representing invoice and remittance transaction management menu choices in accordance with one embodiment of the present invention;

FIG. 8b is a flow chart representing an exemplary workflow script in accordance with one embodiment of the present invention;

FIG. 8c is a flow chart representing an exemplary workflow script in accordance with one embodiment of the present invention;

FIG. 8d is a flow chart representing an exemplary workflow script in accordance with one embodiment of the present invention;

FIG. 8e is a flow chart representing an exemplary workflow script in accordance with one embodiment of the present invention;

FIG. 8f is a flow chart representing an exemplary workflow script in accordance with one embodiment of the present invention;

FIG. 8g is a flow chart representing an exemplary workflow script in accordance with one embodiment of the present invention;

FIG. 8h is a flow chart representing an exemplary workflow script in accordance with one embodiment of the present invention;

FIG. 9a is a flow chart representing exemplary translation processing of an import transaction in accordance with one embodiment of the present invention;

FIG. 9b is a flow chart representing an exemplary translation of an export transaction in accordance with one embodiment of the present invention;

FIG. 10a represents an exemplary client transaction definition in accordance with one embodiment of the present invention;

FIG. 10b represents an exemplary client transaction definition in accordance with one embodiment of the present invention;

FIG. 11a is a table representing exemplary element mapping of an inbound transaction in accordance with one embodiment of the present invention;

FIG. 11b is a table representing exemplary element mapping of an outbound transaction in accordance with one embodiment of the present invention;

FIG. 12a is a block diagram representing an exemplary unattended interface module;

FIG. 12b is a flow chart representing exemplary operation of an unattended interface module;

FIG. 13 is a flow chart representing exemplary operation of an evaluation engine in accordance with one embodiment of the present invention;

FIG. 14a is a table representing exemplary rule application codes in accordance with one embodiment of the present invention;

FIG. 14b is a table representing exemplary mathematical operand codes in accordance with one embodiment of the present invention;

FIG. 14c is a table representing exemplary action codes in accordance with one embodiment of the present invention;

FIG. 14d is a table representing exemplary Boolean operand codes in accordance with one embodiment of the present invention;

FIG. 15a is an exemplary rules configuration document in accordance with one embodiment of the present invention;

FIG. 15b is an exemplary trending evaluation parameter configuration document in accordance with one embodiment of the present invention;

FIG. 15c is an exemplary quantitative evaluation configuration document in accordance with one embodiment of the present invention;

FIG. 16a is a table representing an exemplary trending analysis in accordance with one embodiment of the present invention;

FIG. 16b is a table representing exemplary invoice data point type keys in accordance with one embodiment of the present invention;

FIG. 16c is a table representing exemplary line item data point type keys in accordance with one embodiment of the present invention;

FIG. 16d is a table representing exemplary transaction identifier keys in accordance with one embodiment of the present invention;

FIG. 16e is a table representing exemplary evaluation type keys in accordance with one embodiment of the present invention;

FIG. 17 is a flow chart representing exemplary operation of an evaluation engine in performing trending analysis in accordance with one embodiment of the present invention;

FIG. 18 is a graphic representation of trending analysis in accordance with one embodiment of the present invention;

FIG. 19a is a table representing exemplary quantitative evaluation in accordance with one embodiment of the present invention;

FIG. 19b is a table representing exemplary quantitative evaluation function keys in accordance with one embodiment of the present invention; and

FIG. 20 is a flow chart representing exemplary operation of an evaluation engine in performing quantitative evaluation in accordance with one embodiment of the present invention.

### DETAILED DESCRIPTION OF THE INVENTION

The present invention is now described in detail with reference to the drawings. In the drawings, each element with a reference number is similar to other elements with the same reference number independent of any letter designation following the reference number. In the text, a reference number with a specific letter designation following the reference number refers to the specific element with the number and letter designation and a reference number without a specific letter designation refers to all elements with the same reference number independent of any letter designation following the reference number in the drawings.

It should also be appreciated that many of the elements discussed in this specification may be implemented in hardware circuit(s), a processor executing software code, or a combination of a hardware circuit and a processor executing code. As such, the term circuit as used throughout this specification is intended to encompass a hardware circuit (whether discrete elements or an integrated circuit block), a processor executing code, or a combination of a hardware circuit and a processor executing code, or other combinations of the above known to those skilled in the art.

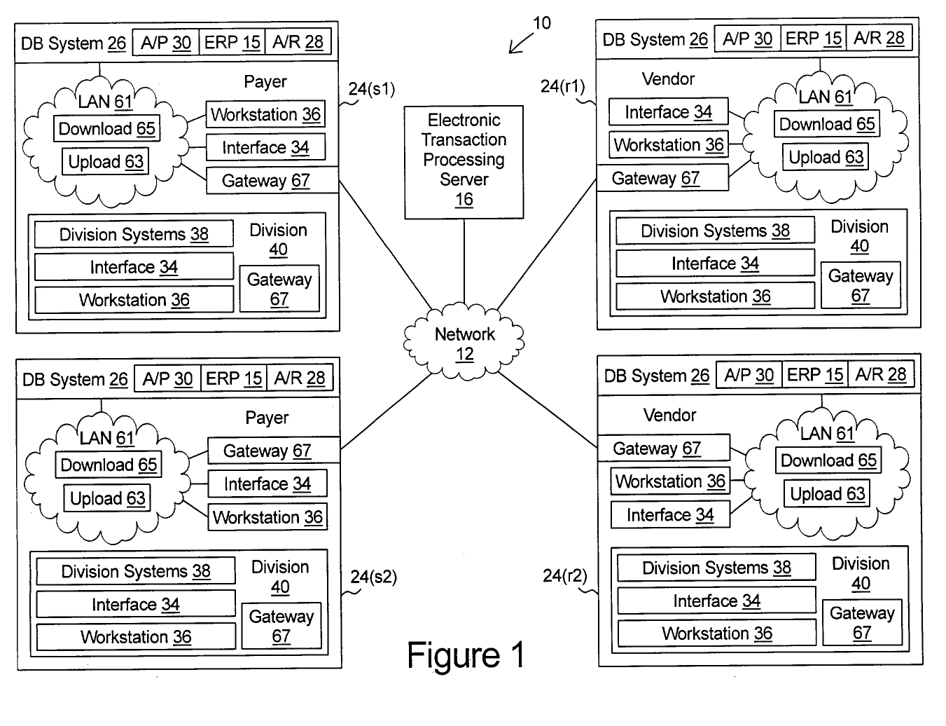

FIG. 1 illustrates exemplary architecture of an automated transaction receipt and management system 10 in accordance with one embodiment of the present invention. The architecture 10 comprises an electronic transaction processing server 16 that is coupled to a community of client systems 24 by a network 12 which may be a TCP/IP compliant network such as the Internet.

Clients

Each client system 24 may both send electronic transactions and receive electronic transactions from other client systems 24 through the electronic transaction processing server 16. For purposes of describing operation, FIG. 1 illustrates four client systems 24, two of which are designated for sending electronic transactions 24S1 and 24S2 and two of which are designated for receiving electronic transactions 24R1 and 24R2.

Each client system 24 may include a local area network 61 that interconnects various systems that may include proprietary database system 26, an unattended interface module 34, and at least one workstation 36.

The database system 26 may comprise an accounts payable system 30, an accounts receivables system 28, and other financial resource planning systems 15 which together provide for recording and managing the client's purchase order, sales order, shipping manifest, invoice, remittance, and other transactions with other clients 24. Each database system 26 may use different transaction definitions for electronically entering and extracting data (either through manual data entry screens or batch input/output files) and, each database system 26 may use different value sets within elements of each transaction definition. For example, the database system 26 of client 24S1 may utilize an invoice transaction that includes identification of a customer using a proprietary customer number from a value set ranging from C-000 to C-999 with a particular customer having a proprietary customer number of C-123. However, the database system 26 of another client 24S2 may identify customers using a different proprietary value set with the same particular customer being assigned a proprietary customer number of “CXN57A”.

The workstation 36 may be a typical personal computer system that includes a web browser for establishing a TCP/IP connection and interfacing with web server systems.

The gateway 67 may be a firewall, network address translation (NAT) server, or other systems for securely coupling the local area network 61 to the network 12 and enabling application layer communications between systems on the network 61 and systems on the network 12.

Unattended Interface Module

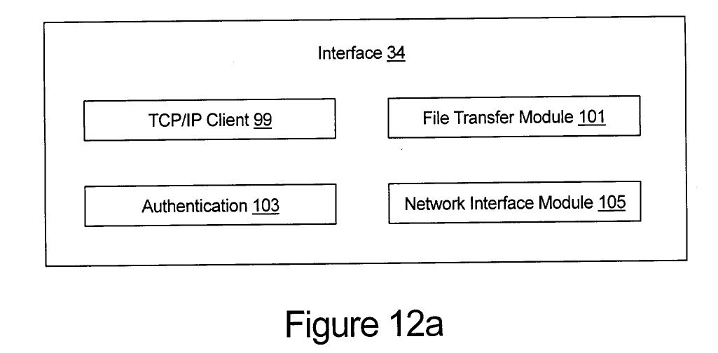

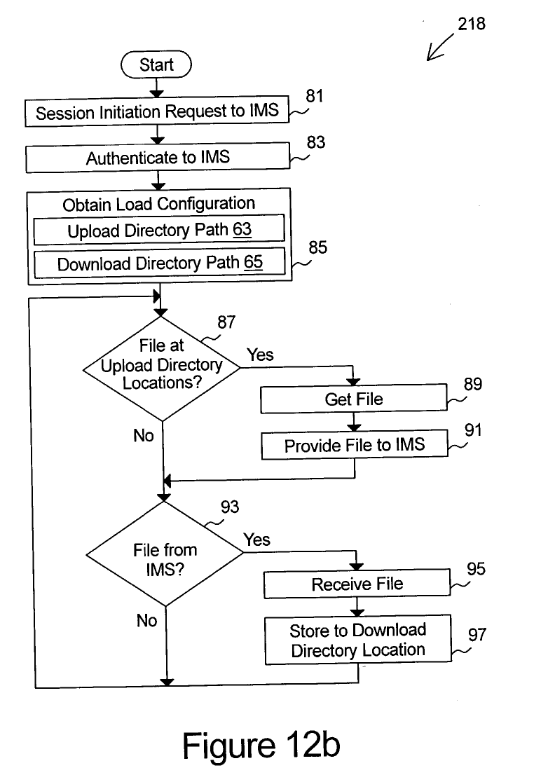

Referring briefly to FIG. 12a, the unattended interface module 34 may include a TCP/IP client system 99 for establishing a secure TCP/IP connection to the electronic transaction processing server 16 on a periodic basis. An authentication module 103 utilizes the TCP/IP connection to appropriately authenticate itself to the server 16 by providing a locally stored login ID and password to the server 16.

A file transfer module 101 requests a client configuration from the server 16 over the TCP/IP connection. The client configuration may include: i) an upload network directory 63 path identifying a directory on network 61 into which the database system 26 may deposit transaction files for uploading to the server 16 (e.g. the upload directory 63); and ii) a download network directory 65 path identifying a directory location on network 61 where database system 26 may periodically look for downloaded transaction files from the server 16.

The file transfer module 101 interacts with a network interface module 105 to utilize the client configuration to locate files in the upload directory 63 and transmit the files to the server 16 through the TCP/IP connection utilizing an HTTP File Transfer system. Similarly, when files are received through the TCP/IP connection from the server 16, the file transfer module and the network interface module 105 may locate the download directory 65 and store the received files therein.

Referring briefly to FIG. 12b, exemplary operation of the unattended interface module 34 is shown. Step 81 represents sending a session initiation request to the electronic transaction processing server 16 over the network 12. Such request may be a TCP/IP connection request sent to the IP address of the electronic transaction processing server 16 on a predetermined port number. The electronic transaction processing server 16 will open a secure session with the unattended interface module 34 in response to such a request and step 83 represents authenticating to the electronic transaction processing server 16 through the secure connection. Authentication may include providing a login ID and password of the unattended interface module 34 to the electronic transaction processing server 16.

Step 85 represents requesting and obtaining a load configuration from the electronic transaction processing server 16. The load configuration may include identification of the upload directory path 63 and the download directory path 65.

Step 87 represents determining whether a file exists at the upload directory path location 63. If yes, then the unattended interface module 34 gets the file at step 89 and provides the file to the electronic transaction processing server 16 through the TCP/IP connection at step 91.

Step 93 represents determining if the electronic transaction processing server 16 is ready to send a file to the unattended interface module 34. If yes, the file is received by the unattended interface module 34 through the TCP/IP connection at step 95. Step 97 represents storing the file in the download directory path location 65.

Returning to FIG. 1, each client system 24 may have one or more division systems 40 that include a local area network 61 interconnecting various systems that may include a division resource management database 38, an unattended interface module 34, a workstation 36, and a gateway 67. Each of the unattended interface module 34, the workstation 36, and the gateway 67 may include the same structure and functions as discussed with respect to the client 24. The division resource management database 38 may include an accounts payable system, an accounts receivables system, and other transaction systems that utilize different transaction definitions and different value sets than the client database system 26.

Electronic Transaction Processing Server

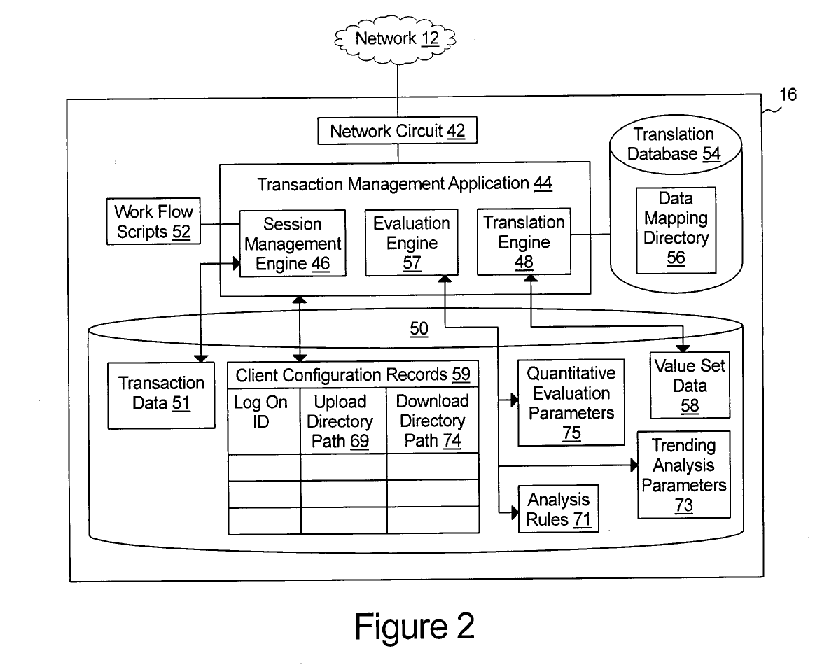

Turning to FIG. 2, exemplary structure of the electronic transaction processing server 16 is shown. The server 16 seamlessly: i) manages the electronic exchange of transactions amongst the client systems 24 (and the division systems 40) by independently communicating transactions with each such client system 24 (or division system 40) using transaction definitions and value sets that are compatible with such client's (or division's) database system 26 or 38 respectively; and ii) provides an automated transaction analysis of transaction data in accordance with predefined parameters established by the clients.

The server 16 includes a transaction management application 44 that is coupled to a network circuit 42 and a database 50.

The network circuit 42 includes circuitry for interfacing between the transaction management application 44 and the network 12. In the exemplary embodiment, the circuitry may include appropriate routers, firewalls, and perimeter networks to provide for a secure interface and to prevent unauthorized access to the transaction management application 44 by other computing devices coupled to the network 12.

Database

The database 50 may be a relational database and store transaction data 51, client configuration records 59, value set data 58, analysis rules 71, trending analysis parameters 73, and quantitative evaluation parameters 75, each in a table structure.

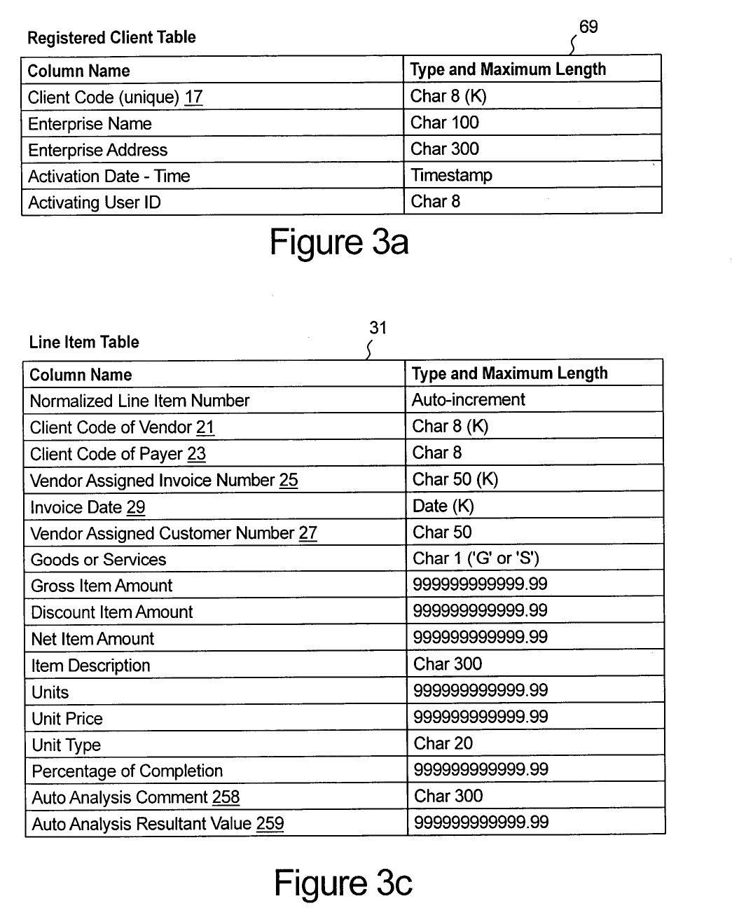

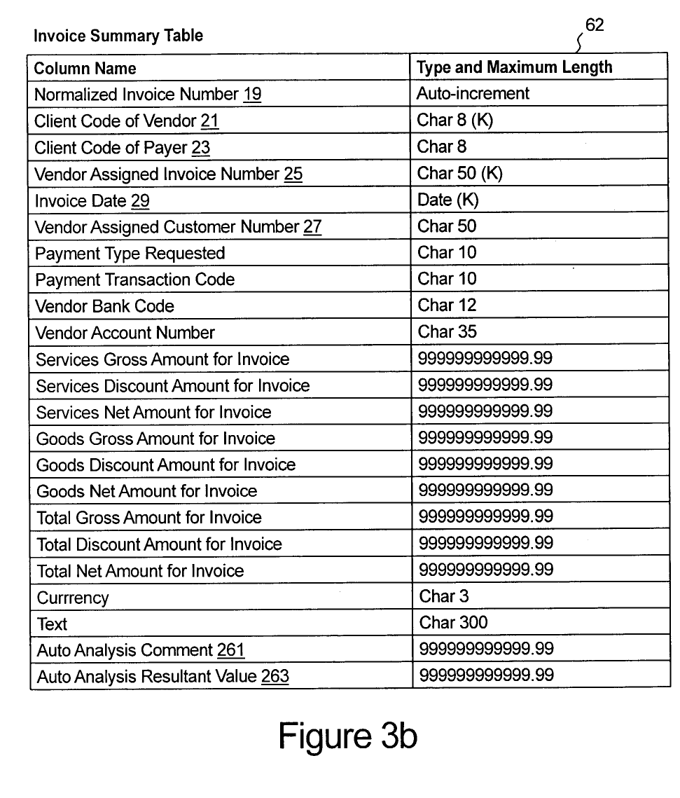

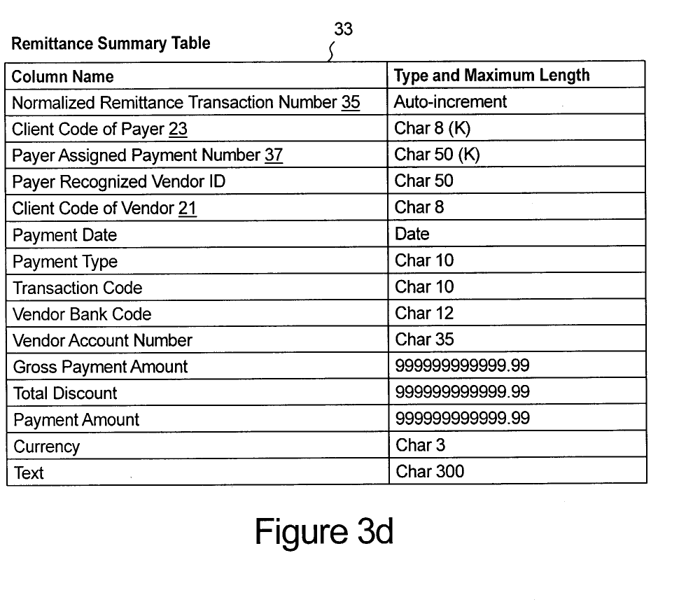

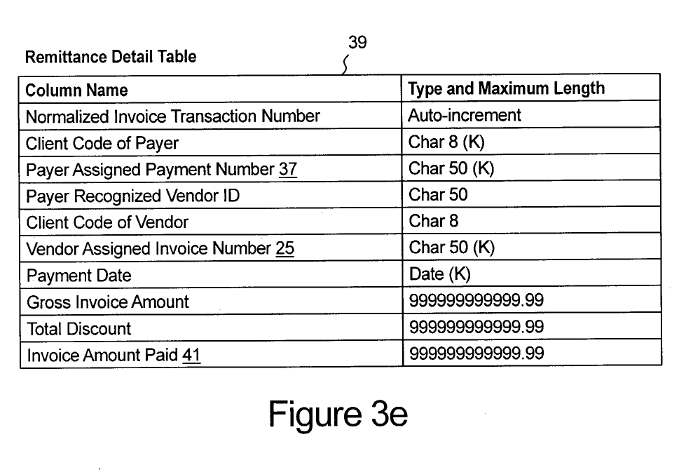

Turning to FIGS. 3a-3e, exemplary table structures for storage of invoice and remittance transactions within the transaction data tables 51 are shown. The registered client table 69 of FIG. 3a associates a client's identification information such as the client's enterprise name and address with a unique normalized client code 17.

The invoice summary table 62 of FIG. 3b, associates a unique normalized invoice transaction number 19 to each invoice transaction managed by the electronic transaction processing server 16. Associated with the unique normalized invoice transaction number 19 are a plurality of fields comprising the normalized client code of the vendor 21, the normalized client code of the customer 23, a vendor assigned invoice number 25, a vendor assigned customer number 27 for the customer, and an invoice date 29.

Because the quantity of line items on an invoice is variable, line item information is stored in a line item table 31 as represented by FIG. 3c. The line item table 31 associates line item detail for each line item on an invoice to the particular invoice using the vendor assigned invoice number 25, the invoice date 29, the normalized client code of the vendor 21, and the vendor assigned customer number 27.

The remittance summary table 33 of FIG. 3d associates a unique normalized remittance transaction number 35 to each remittance transaction managed by the electronic transaction processing server 16. Associated with the unique normalized remittance transaction number 35 are a plurality of fields including the normalized client code of the customer 23 (typically referred to as a payer for a remittance transaction), the normalized client code of the vendor 21 (typically referred to as a biller for a remittance transaction), and a payer assigned payment number 37.

Because each remittance may apply to one or more vendor invoices (in whole or in part), each remittance payment can be considered to have a variable number of line items. As such, remittance line item information that includes identification of the paid invoices is stored in the remittance detail table 39 represented by FIG. 3e. The remittance detail table 39 associates remittance detail such as the vendor assigned invoice number 25 and the amount of the invoice paid 41 to the payer assigned payment number 37.

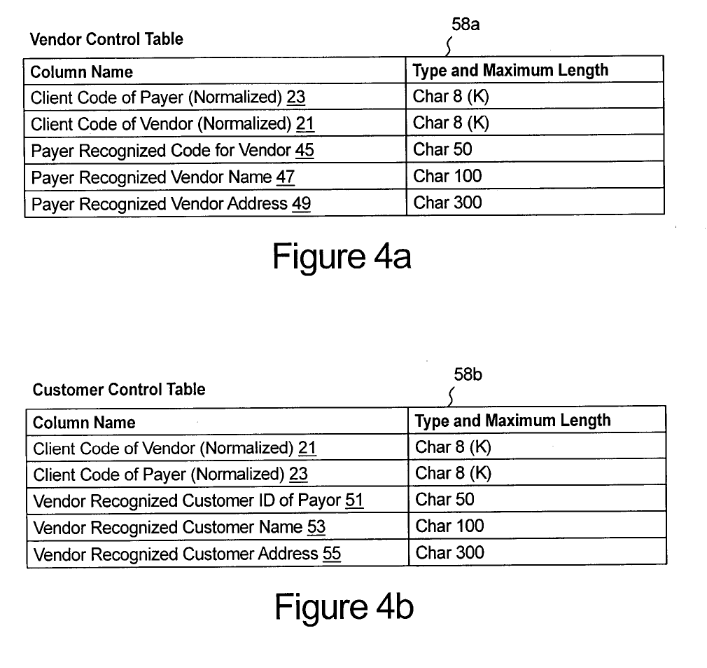

Returning to FIG. 2, because each client may recognize other clients by customer numbers and vendor numbers that comprise different value sets than the normalized client ID numbers 21 & 23, the value set data tables 58, represented by FIGS. 4a and 4b associate value sets of each client transaction definition to normalized value sets. Referring to FIGS. 4a and 4b in conjunction with FIG. 2, the vendor control value set table 58a includes a plurality of records, each of which associates a proprietary vendor ID code 45, vendor name 47, and vendor address 49 (e.g. assigned by the customer) to each vendor (as identified by the normalized client code of the vendor 21). Further, it should be appreciated that a single vendor identified by a normalized client code 21 may be recognized to a customer/ payer as multiple vendors (for example, the customer/payer may recognize different branches or different divisions as separate vendors). As such, each separate branch or division may be assigned a different proprietary customer/payer recognized vendor ID code 45, vendor name 47, and vendor address 49 within the table 58a.

Similarly, the customer control value set table 58b, associates a proprietary customer ID code 51, customer name 53, and customer address 55 (e.g. assigned by the vendor) to each customer (as identified by the normalized client code of the customer 23). Again it should be appreciated that a single customer identified by a normalized client code 23 may be recognized to a vendor as multiple customers, with each brand or division being assigned a different proprietary customer ID code 51, customer name 53, and customer address 55 within the table 58b.

Transaction Management Application

Returning to FIG. 2, the transaction management application 44 includes applicable circuits for establishing and managing a secure session with each unattended interface 34 and each workstation 36 via the network circuit 42.

The transaction management application 44 further includes a session management engine 46 that controls the interface of invoice and remittance transaction files between the server 16 and the unattended interface module 34 or workstation 28 during the secure session in accordance with workflow scripts 52.

The transaction management application 44 further yet includes a translation engine 48 for interfacing invoice and payment transactions between the invoice and remittance tables 51 of database 50 and each interface module 34 and workstation 36 using transaction definitions and value sets that are compatible with the client database system 26 (or division database system 38) for which such unattended interface module 34 or workstation 36 is operating.

Session Management Engine

The session management engine 46 operates a menu driven application for each of the unattended interface modules 34 and work stations 36 that have open communication sessions to the transaction management application 44.

During operation the session management engine 46 receives client instructions to perform various predetermined transaction management operations and then performs processing steps in response thereto in accordance with workflow scripts 52.

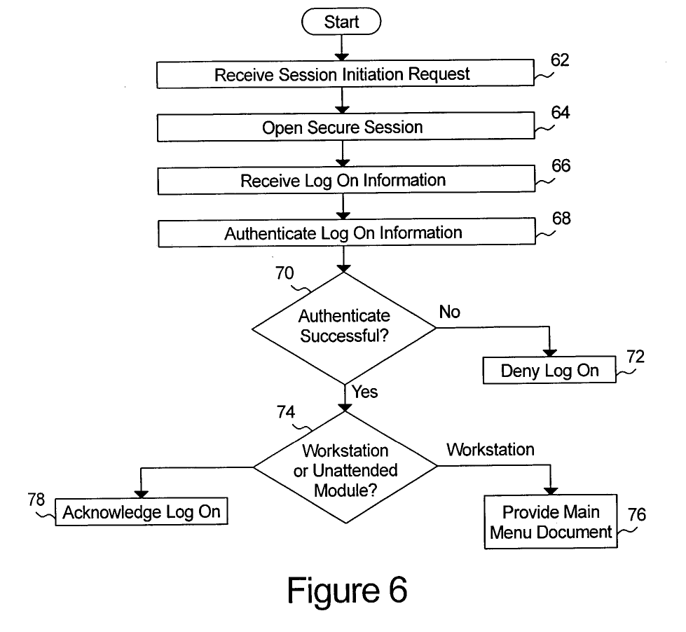

Turning to the flowchart of FIG. 6 in conjunction with FIG. 2, exemplary steps performed by the session management engine 46 to logon each unattended interface module 34 or workstation 36 and to initiate invoice management following logon are shown.

Step 62 represents receipt of a session initiation request from the client (e.g. the workstation 36 or the unattended interface module 34). Step 64 represents opening a secure session with the client and step 66 represents receiving logon information from the client that may include a client ID number and password. At step 68 the logon information is authenticated by comparing it to a password database and, at step 70, if the logon information does not authenticate, access is denied at step 72.

In the exemplary embodiment, the password table will also include an identifier as to whether the client is a workstation 36 or an unattended interface module 34. As such, if the logon information does authenticate at step 70, then at step 74 the session management engine 46 may determine that the client is a workstation 36 and proceed to step 76 wherein a main menu document is provided to the workstation 36 or determine that the client is an unattended interface module 34 and proceed to step 78 wherein the logon is acknowledged to the unattended interface module 34.

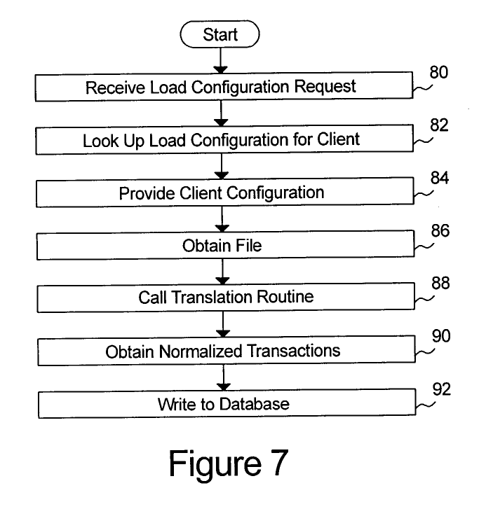

After the unattended interface module 34 completes logon, the flow chart of FIG. 7 represents exemplary steps performed by the session management engine 46 for interacting with the unattended interface module 34. Referring to FIG. 7 in conjunction with FIG. 2, Step 80 represents receiving a request for a file-loading configuration from the unattended interface module 34. Step 82 represents looking up the file loading configuration applicable for the client from the translation database 56 and step 84 represents providing the file loading configuration data to the unattended interface module 34. The file loading configuration may include identification 69 of the upload directory path 63 and identification 74 of the download directory path 65.

Step 86 represents obtaining the file from the unattended interface module 34. In the exemplary embodiment, the unattended interface module 34 will send the file through the secure session and write the file to a predetermined location within the database 50 or to a predetermined location within the directory structure of the electronic transaction processing server 16. The session management engine 46 will then retrieve the file from such location.

Step 88 represents calling the translation routine of the translation engine 48 (discussed later herein) to convert each transaction of the file from the client transaction definition and value set to a normalized transaction definition and value set.

Step 90 represents receiving each normalized transaction from the translation engine 48 and step 92 represents loading the normalized transactions into the invoice and payment records 51 in the database 50.

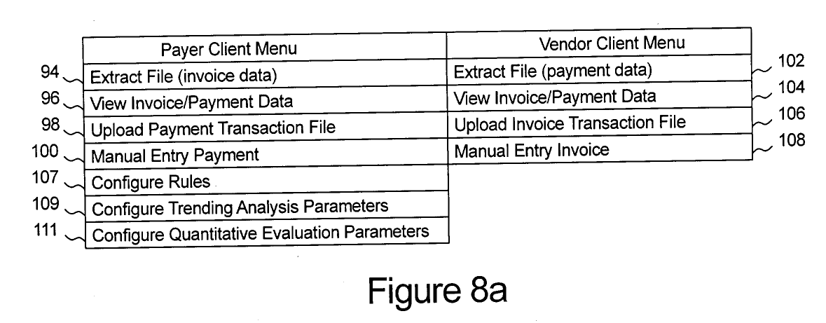

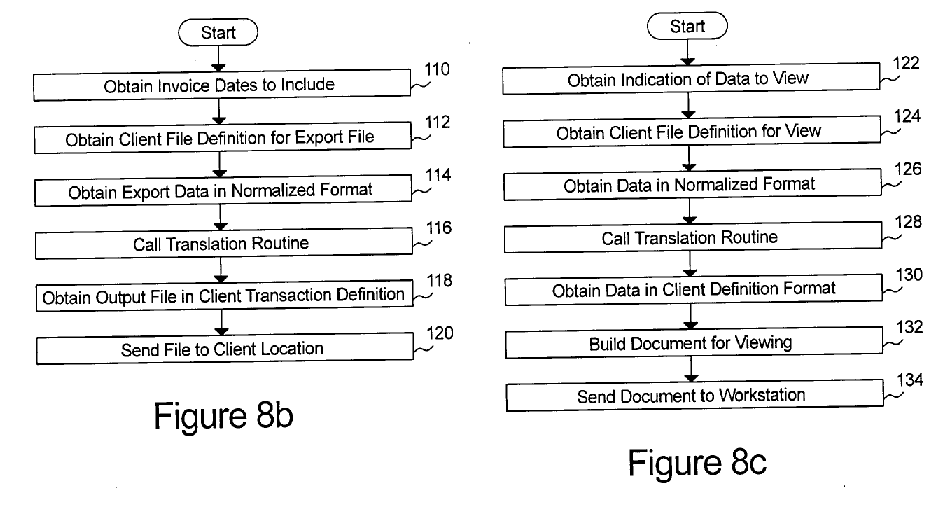

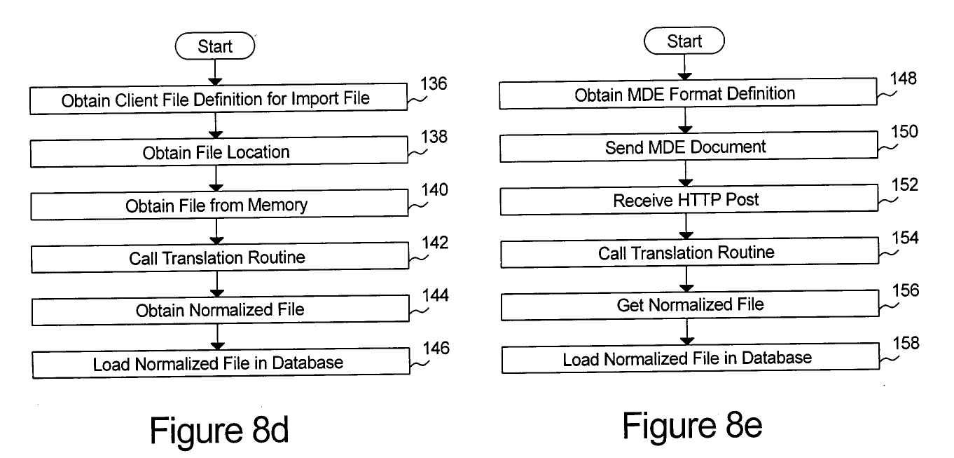

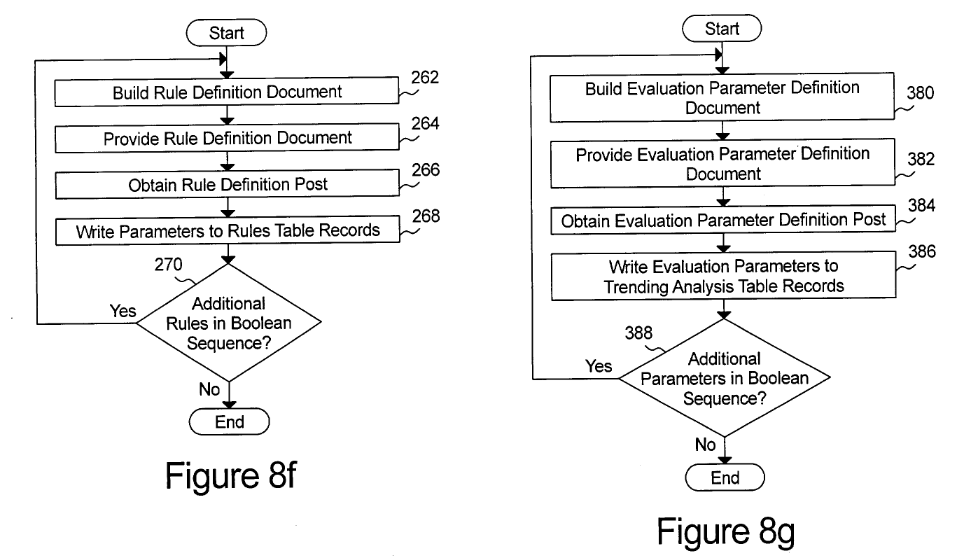

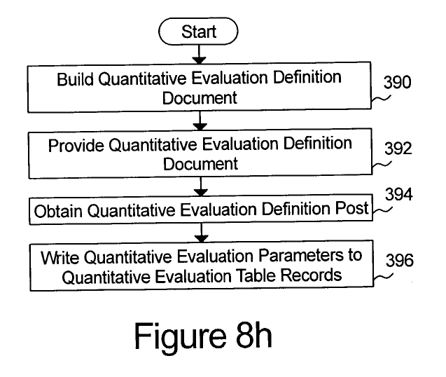

After logon of a workstation 36 is complete the main menu document provided to the workstation 36 at step 76 of FIG. 6 includes transaction management menu choices such as choices for managing invoice and remittance transactions as a payer client or as a vendor client with exemplary menu choices for each represented by the table of FIG. 8a. When managing invoice and remittance transactions as a payer, exemplary management operation may include extracting a file of incremental invoice transactions from the database 94, viewing invoice and/or payment data 96, uploading a file of payment transactions 98, and manual data entry of a payment 100.

When managing invoice and remittance transactions as a vendor, exemplary management operations may include extracting a file of incremental payment transactions from the data base 102, viewing invoice and/or payment data 104, uploading a file of invoice transactions 106, and manual data entry of an invoice 108.

Turning to the flowchart of FIG. 8b in conjunction with FIG. 2, exemplary steps for extracting a file of incremental invoice or remittance transactions (94 and 102 of FIG. 8a) are shown. Step 110 represents obtaining an indication of the incremental transactions to include in the extracted file. In the exemplary embodiment, the session management engine 46 provides a document to the workstation 36 to prompt the user of the workstation 36 to enter a start date and an end date such that the incremental transactions are those that fall between such dates. It should be appreciated that the extracted file may cover a time period in which, in the case of invoice transactions, will include invoice transactions from multiple vendors for the payer and in the case of remittance transactions may include multiple remittance transactions from multiple customers of the vendor.

Step 112 represents obtaining the client file definition for the export file. The session management engine 46 may obtain this by either looking up a transaction definition associated with the particular client 24 in an applicable database file or by providing a document to the workstation 36 to prompt the user of the workstation 36 to select from available client transaction definitions.

Step 114 represents obtaining the incremental transactions from the database 50 in the normalized format. Step 116 represents calling the translation routine of the translation engine 48 and step 118 represents receiving the transactions from the translation engine 48 that are compatible with the client transaction definition and with client value sets. Step 120 represents building a file of the incremental transactions (including transaction comments and resultant values that have been written to transaction tables as discussed herein) and sending the file to the workstation 36 through the secure session.

The flowchart of FIG. 8c represents exemplary steps associated with viewing invoice/payment transactions (96 and 104 of FIG. 8a).

Step 122 represents obtaining an indication of the transactions that the user of the workstation 36 desires to view. This may include providing the workstation 36 with documents representing menus of choices for user selection and obtaining a post of the user selection through the secure session.

Step 124 represents obtaining the client transaction definition for the transactions to be viewed either through operator selection of available definitions or by looking up a client transaction definition that is associated with the client 24 in an applicable database file.

Step 126 represents obtaining normalized transaction data from the database that corresponds with the indication obtained at step 122. Step 128 represents calling the translation routine of the translation engine 48 and step 130 represents obtaining the transaction compatible with the client transaction definition and with client value sets from the transaction engine 48. Step 132 represents building a document (including transaction comments and resultant values that have been written to transaction tables as discussed herein) to display the transactions and step 134 represents sending the document to the workstation 36 through the secure session.

The flowchart of FIG. 8d represents exemplary steps performed by the session management engine 46 in response to user selection of uploading a file (98 or 106 of FIG. 8a).

Step 136 represents obtaining the client transaction definition for the file to be imported either through operator selection of available definitions or by looking up a client transaction definition that is associated with the client 24 in an applicable database file. Step 138 represents obtaining the file location from the workstation 36 and providing the workstation 36 with applicable scripts to upload the file from the location through the secure session and write the file to a predetermined location.

Step 140 represents obtaining the file from the predetermined location and step 142 represents calling the translation routine of the translation engine 48. Step 144 represents obtaining the normalized transactions from the translation engine 48 and step 146 represents loading the transaction into the invoice and payment records 51 of the database 50.

The flowchart of FIG. 8e represents exemplary steps performed by the session management engine 46 to provide manual entry of invoice or payment data (100 and 108 of FIG. 8a).

Step 148 represents obtaining the client transaction definition for the file to be imported either through operator selection of available definitions or by looking up a client transaction definition that is associated with the client 24 in an applicable database file.

Step 150 represents sending a manual data entry document compliant with the client transaction definition to the workstation 36. Step 152 represents receiving a post of the manually entered transaction back from the workstation 36 over the secure session.

Step 154 represents calling the translation routine of the translation engine 48 and step 156 represents receiving the normalized transaction back from the translation engine 48. Step 158 represents loading the normalized transaction into the invoice and payment records 51 of the database 50.

FIG. 8f represents exemplary steps performed by the session management engine 46 to obtain client input of evaluation engine rules following log-on of a client workstation 36 and client selection of a menu option to configure rules 107 (FIG. 8a) following provision of a main menu document at step 76 (as set forth in FIG. 6).

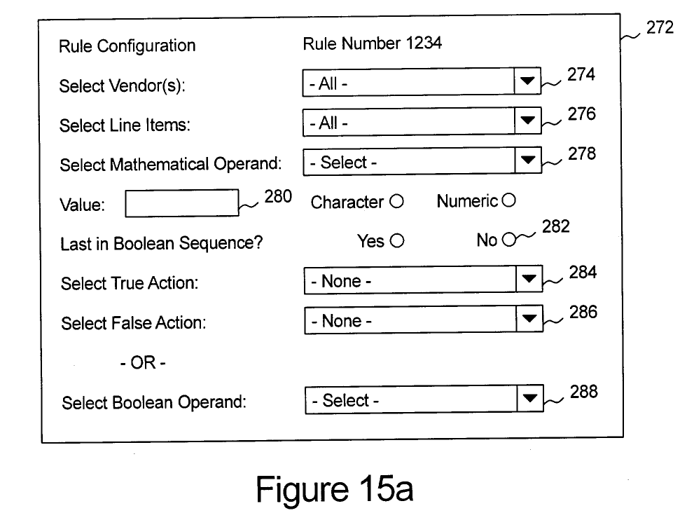

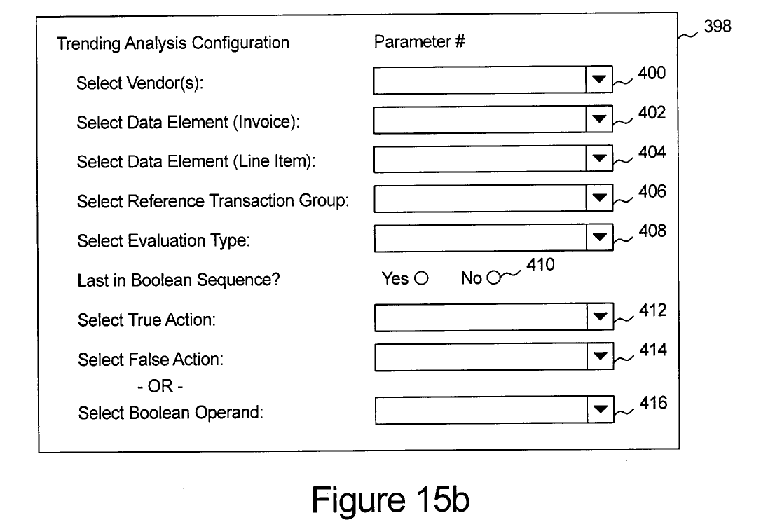

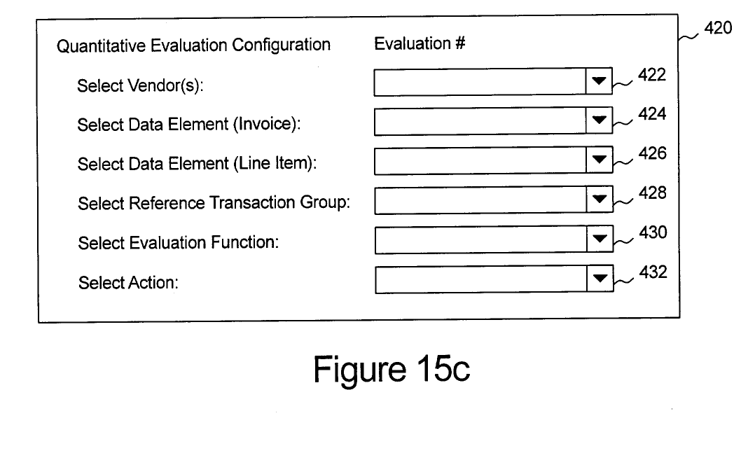

Step 262 represents building a rules configuration document. Turning briefly to FIG. 15a, the rules configuration document 272 may by an HTML document that includes fields that provide for the user of a work station 36 receiving the document to select vendors to which the rule is applicable, line items to which the rule is applicable, a mathematical operator for the rule, a value type, a value, a true action, a false action, an indication of whether the rule is the last in a Boolean series, and a Boolean operator for combination with another rule if not the last rule in the Boolean series.

More specifically, the rules configuration document 272 may include: a) field 274 which is a menu bar drop down list of vendor clients (that are trading partners with the payer client) for selection of the vendor(s) to which the rule will apply; b) field 276 which is a menu bar drop down list of line item selection choices for selection of line items to which the rule applies; c) field 278 which is a menu bar drop down list of mathematical operands that may be selected for application of the rule; d) field 280 for user input of a rule value and selection of whether the value is numeric or character; e) field 282 for user indication of whether the rule is the last in a Boolean sequence; f) fields 284 and 286 which may be menu bar drop down lists for selection of true actions and false actions to be taken based on the rule result (if the rule is the last in the Boolean sequence); and g) field 288 which may be a menu bar drop down list for selection of a Boolean operand for combining the result with the next rule (if the rule is not the last in the Boolean sequence). Each of these parameters is discussed in more detail herein.

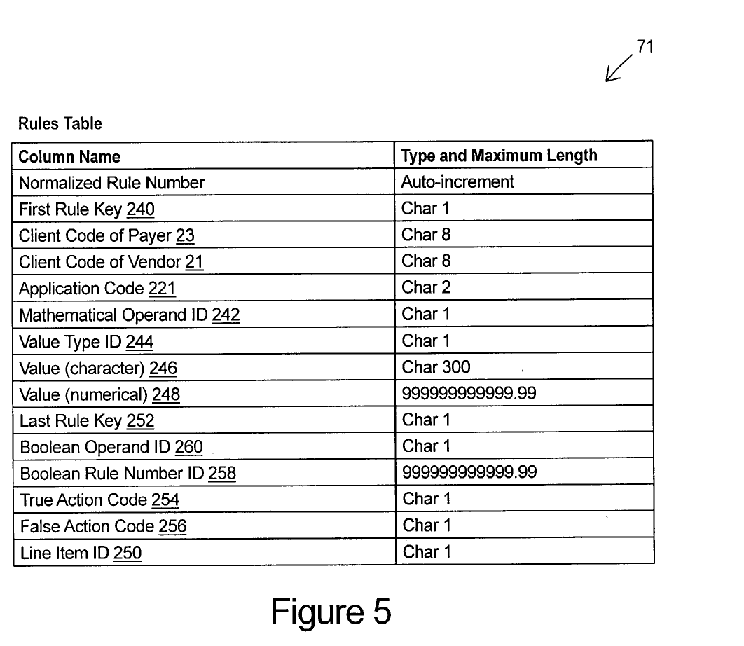

Returning to FIG. 8f, step 266 represents obtaining a post from the work station that includes the selected rule parameters from the rule definition document 272. Step 268 represents writing the input rule parameters (or an indication of the selected parameters) to a record in the rules definition table 71 (FIG. 5).

At step 270, if the rule was the last in the Boolean sequence, the system terminates rule definition operation. However, if there are additional rules in the Boolean sequence, the system returns to step 262 wherein the steps are repeated for definition of the next rule in the sequence.

FIG. 8g represents exemplary steps performed by the session management engine 46 to obtain client input of trending evaluation parameters following log-on of a client workstation 36 and client selection of a menu option to configure trending analysis parameters 109 (FIG. 8a) following provision of a main menu document at step 76 (as set forth in FIG. 6).

Step 380 represents building a trending analysis configuration document and step 382 represent providing such document to the work station 36. Turning briefly to FIG. 15b, the trending analysis configuration document 398 may by an HTML document that includes fields that provide for the user of a work station 36 receiving the document to select vendors to which the analysis parameter set is applicable, invoice level data elements to which the analysis parameter set is applicable, line item level data elements to which the analysis parameter set is applicable, a reference transaction group, an evaluation type, a true action, a false action, an indication of whether the analysis parameter set is the last in a Boolean series, and a Boolean operator for combination with another analysis parameter set if not the last analysis parameter set in the Boolean series.

More specifically, the rules configuration document 398 may include: a) field 400 which is a menu bar drop down list of vendor clients (that are trading partners with the payer client) for selection of the vendor(s) to which the evaluation parameter set will apply; b) field 402 which is a menu bar drop down list of invoice level data elements to which the evaluation parameter set will apply; c) field 404 which is a menu bar drop down list of line item level data elements to which the evaluation parameter set will apply; d) field 406 which is a menu bar drop down list of reference transaction groups; e) field 408 which is a menu bar drop down list of evaluation threshold functions; f) field 412 for user indication of whether the rule is the last in a Boolean sequence; g) fields 412 and 414 which may be menu bar drop down lists for selection of true actions and false actions to be taken based on the rule result (if the rule is the last in the Boolean sequence); and h) field 416 which may be a menu bar drop down list for selection of a Boolean operand for combining the result with the next rule (if the rule is not the last in the Boolean sequence). Each of these parameters is discussed in more detail herein.

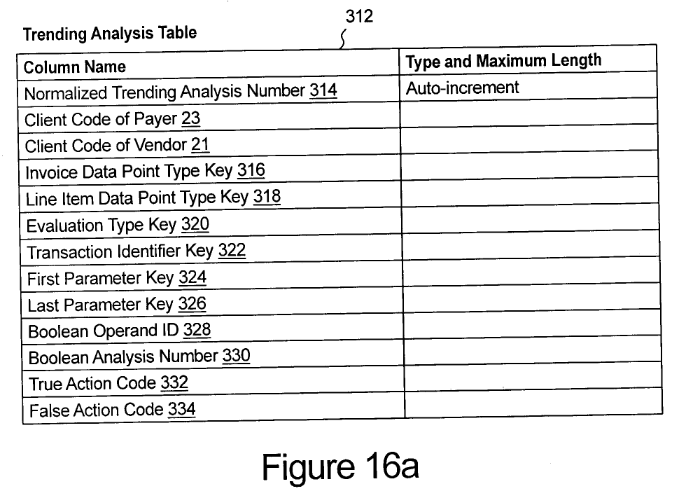

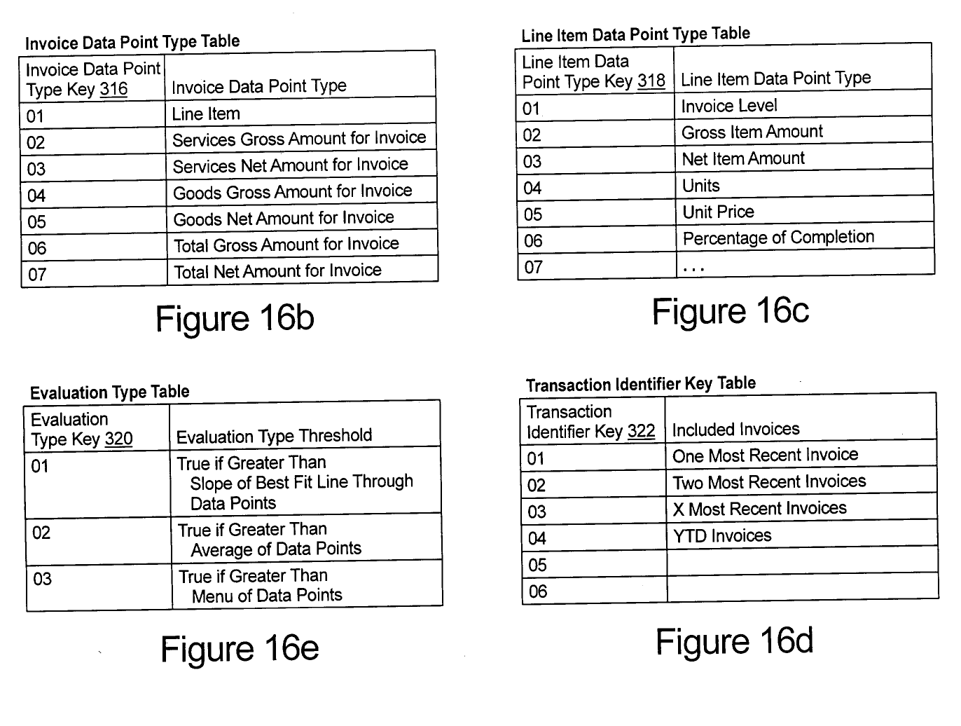

Returning to FIG. 8g, step 384 represents obtaining a post from the work station 36 that includes the selected trending analysis parameters from the trending analysis parameter document 398. Step 386 represents writing the analysis parameters (or an indication of the selected parameters) to records within the tables of FIGS. 16a-16e.

At step 388, if the rule was the last in the Boolean sequence, the system terminates rule definition operation. However, if there are additional rules in the Boolean sequence, the system returns to step 380 wherein the steps are repeated for definition of the trending analysis parameter set in the sequence.

FIG. 8h represents exemplary steps performed by the session management engine 46 to obtain client input of quantitative evaluation functions following log-on of a client workstation 36 and client selection of a menu option to configure quantitative evaluation parameters 111 (FIG. 8a) following provision of a main menu document at step 76 (as set forth in FIG. 6).

Step 390 represents building a quantitative evaluation configuration document and step 392 represents providing such document to the client workstation 36. Turning briefly to FIG. 15c, the quantitative evaluation configuration document 420 may by an HTML document that includes fields that provide for the user of a work station 36 receiving the document to select vendors to which the evaluation is applicable, invoice level data elements to which the evaluation is applicable, line item level data elements to which the evaluation is applicable, a reference transaction group, an evaluation function, and an action.

More specifically, the quantitative evaluation configuration document 420 may include: a) field 422 which is a menu bar drop down list of vendor clients (that are trading partners with the payer client) for selection of the vendor(s) to which the evaluation will apply; b) field 424 which is a menu bar drop down list of invoice level data elements for selection of data elements to which the evaluation will apply; c) field 426 which is a menu bar drop down list of line item level data elements for selection of data elements to which the evaluation will apply field 278; d) field 428 for user selection of a reference transaction group; e) field 430 for user selection of an evaluation function; and f) field 432 for user selection of an action for execution following completion of the quantitative evaluation. Each of these parameters is discussed in more detail herein.

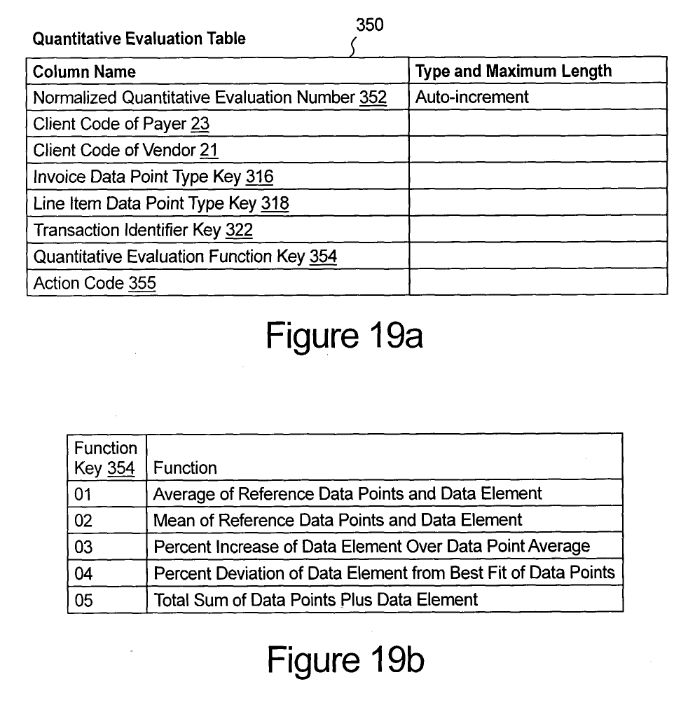

Returning to FIG. 8h, step 394 represents obtaining a post from the work station that includes the selected evaluation parameters from the quantitative evaluation configuration document 420 and step 396 represents writing the input evaluation parameters (or an indication of the selected parameters) to the tables of FIGS. 19a and 19b.

Translation Engine

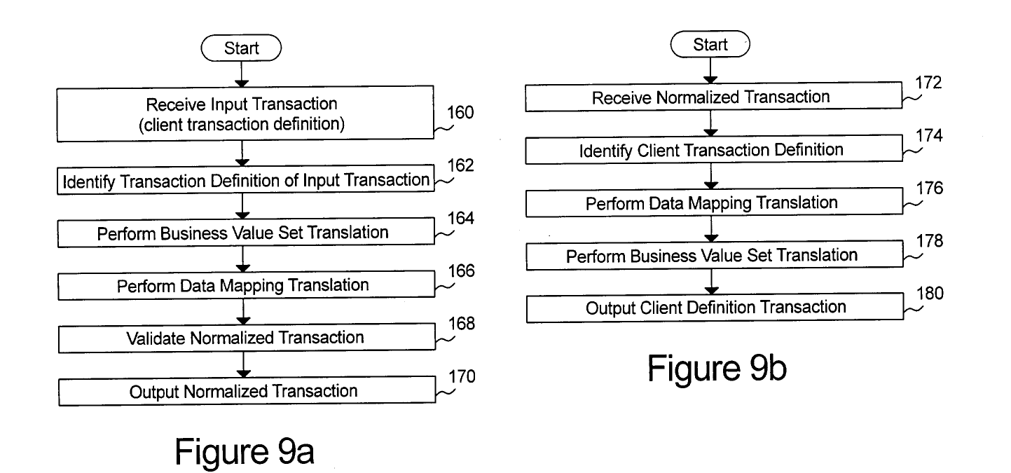

Turning to FIGS. 9a and 9b in conjunction with FIG. 2, exemplary operation of the translation engine 48 is shown. The translation engine 48 translates invoice transactions between a client transaction definition and value set compatible with a client's database system 26 (or a division's database system 38) and a normalized transaction definition and value set compatible with the invoice and payment records 51 in the database 50. Referring to FIG. 8a, operation of the translation engine 48 with respect to translating a transaction from a client definition transaction to a normalized transaction is shown.

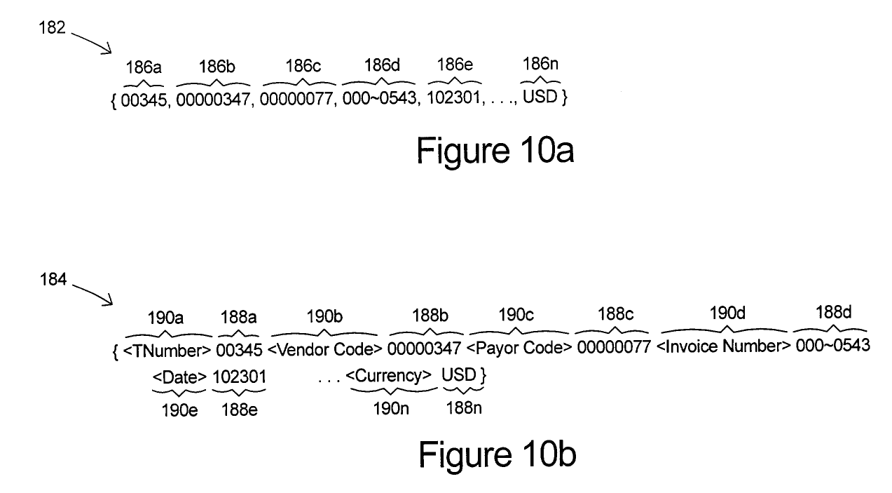

Step 160 represents receipt of a transaction corresponding to the client transaction definition. Referring briefly to FIGS. 10a and 10b, portions of exemplary client transactions are represented. Exemplary transaction 182 is a comma delimited transaction definition that includes a plurality of data elements 186a-186n each of which is separated from adjacent data elements 186a-186n by a comma symbol. Each data element 186a-186n is identified by its sequential location within the transaction (e.g. data element 186e which is the 5^{th} data element in the transaction represents invoice date) and includes data that corresponds with transaction format rules. For example, the transaction format rules that correspond to the invoice date may require that the date element 186e contain 6 digits in a MMDDYY format.

Exemplary transaction 184 is a tagged data element transaction definition that includes a plurality of data elements 188a-188n each of which is positioned following an element tag 190a-190n that identifies the contents of the following data element 188a- 188n. Again, the data within each element complies with transaction format rules.

It should be appreciated that the exemplary transactions 182 and 184 each represent only a portion of a transaction. An actual transaction may consist of many more elements and the permutations of client transaction definitions may be large.

Step 162 represents identifying the particular client transaction definition with which the received transaction complies. In the exemplary embodiment, the session management engine 46 will provide a transaction definition type indicator to the translation engine when it calls the translation routine. The transaction definition type indicator will correspond to the type of transaction that the client system indicated. However, it is envisioned that the translation engine 48 may independently determine the client transaction definition type.

Step 164 represents performing business value set translation. Because each client database system 26 (and each division database system 38) may identify other clients, products, services, and other invoice information by different value sets, the value sets must be normalized. For example, a particular client 24 may be identified by a unique client number, client 123 for example, in the normalized transaction. However, the clients database system 26 requires a vendor number and the vendor number that corresponds to client 123 may be V319 for example. As such, the translation engine 48 relies on client specific business value translation tables 58 to map business values from client specific values in the client transaction to normalized values.

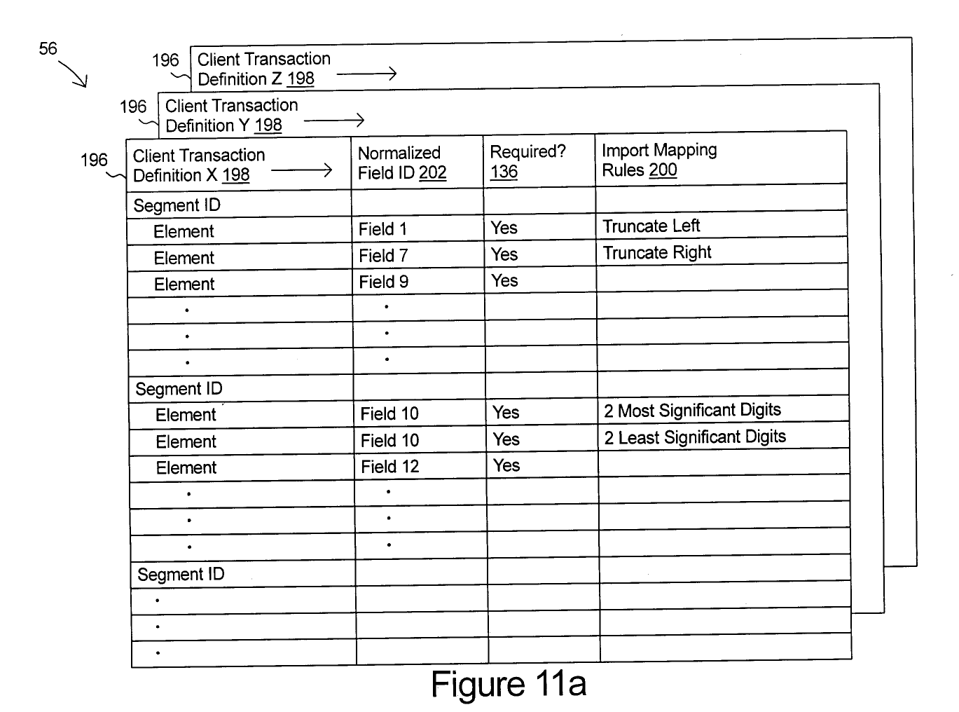

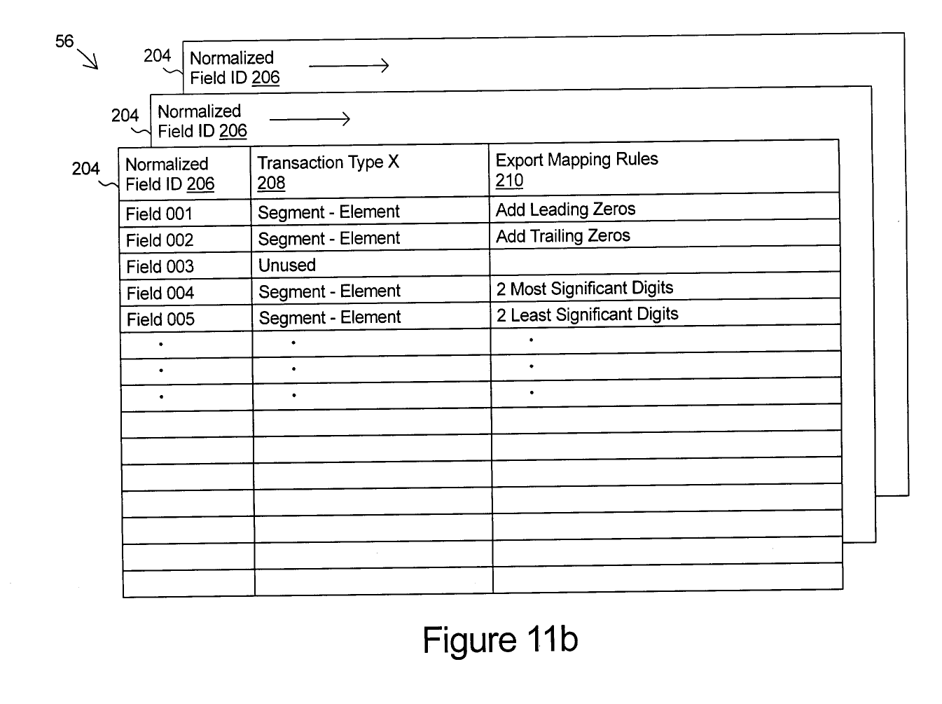

Step 166 represents performing data mapping translation. Referring briefly to FIG. 11a, to perform data mapping translation, the translation engine relies on a data mapping table 196 for each of the possible client transaction definitions that are stored in the data mapping database 56. Each data mapping table 196 associates a client transaction field 198 and mapping rules 200 to each field 202 in the normalized transaction. The required field136 also indicates whether the field is required for purposes of validation discussed later herein. Because each field in a normalized transaction may include data that is only a portion of a field from a client transaction (for example, a client transaction date field may include a month, day, and year organized as MMDDYYYY while the normalized transaction may include three separate fields identified as month, day, and year), the mapping rules 200 may indicate which portion of the client transaction field to map to the normalized transaction field. Because the normalized transaction field may be either longer or shorter than the client transaction filed, the mapping rules 200 may indication which characters to truncate or which characters to add as default characters.

After performing both business value translation and data mapping translation, the normalized data must be validated at step 168. The translation engine 48 validates the normalized transaction by assuring that each field identified as required in the mapping table 196 is included and that the data within each such required field matches field requirements.

Step 170 represents outputting the normalized transaction to the session management engine 46.

Turning to FIG. 9b, exemplary steps for translating a normalized transaction to a transaction compliant with a client transaction definition are shown. Step 172 represents receiving the normalized transaction and step 174 represents identifying the client transaction definition required. In the exemplary embodiment, the client transaction definition will be provided as a client transaction indicator by the session management engine 46.

Step 176 represents performing data mapping translation. Referring briefly to FIG. 11b, to perform data mapping translation, the translation engine 48 relies on mapping tables 204 that are stored in the data mapping database 56. The mapping tables 204 associate each normalized data field 206 to a client transaction definition data field 208 (if required) and to mapping rules 210.

Because the client transaction definition data field 208 may require data from one or more normalized fields 206 (e.g. the date field example discussed earlier), the mapping rules may identify that the normalized field 206 is mapped to a specific sub portion of the client transaction definition field 208. Because the client transaction data field 208 may have more or fewer characters, the mapping rules may indicate which characters to truncate and/or default characters to add.

Step 178 represents performing business value translation. As discussed with respect to step 164, business value translation is performed utilizing business value translation tables 58.

Step 180 represents outputting the transaction that complies with the client transaction definition to the session management engine 46.

Evaluation Engine

Rules Analysis

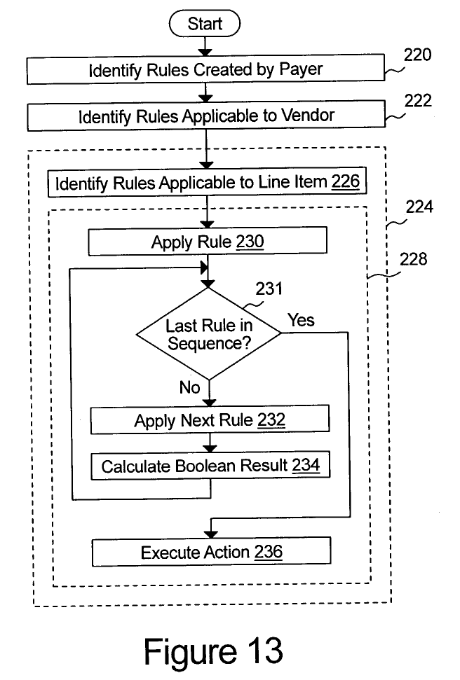

The evaluation engine 57 provides rules analysis, trending analysis, and quantitative analysis of transaction data. FIG. 5 represents an exemplary rules analysis table 71 and FIG. 13 represents exemplary operation of the evaluation engine 57 in performing a rules analysis when an invoice transaction has been loaded into the transaction data tables 51.

The analysis rules table 71 associates a plurality of rules, interconnected by Boolean operators, that a customer may use to evaluate invoice line items on invoices provided by its vendors. The table 71 associates a unique normalized rule number to each rule entered by a payer in accordance with the systems discussed herein. Associated with the unique normalized rule number are a first rule key 240, the client code of the payer 23, the client code of the vendor 21, an application code 221, a mathematic operand ID field 242, a value type ID field 244, a character value field 246, a numerical value field 248, a last rule key 252, a Boolean operand ID field 260, a Boolean rule number ID field 248, a true action code 254 and a false action code 256.

Step 220 represents identifying those rules from the rules table 71 that were created by the payer of the invoice transaction. This step may be performed by identifying those rules that include the same client code of the payer 23 as the invoice transaction.

Step 222 represents identifying those rules (from the set of rules that has already been identified in step 220) that are applicable to the vendor of the invoice transaction. This step may be performed by identifying those rules that include the same client code of the vendor 21 as the invoice transaction.

The steps of group 224 are then performed for each line item of the invoice transaction. Step 226 represents identifying those rules (from those already identified at step 222) that are applicable to the line item. This step may be accomplished by identifying the application code 221 of the rule and determining whether such application code 221 is applicable to the line item.

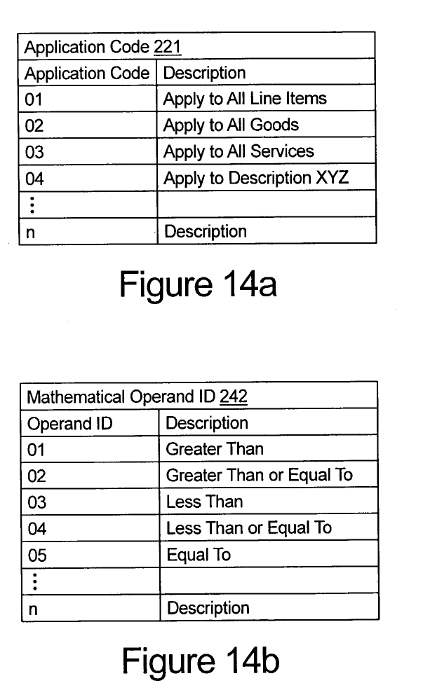

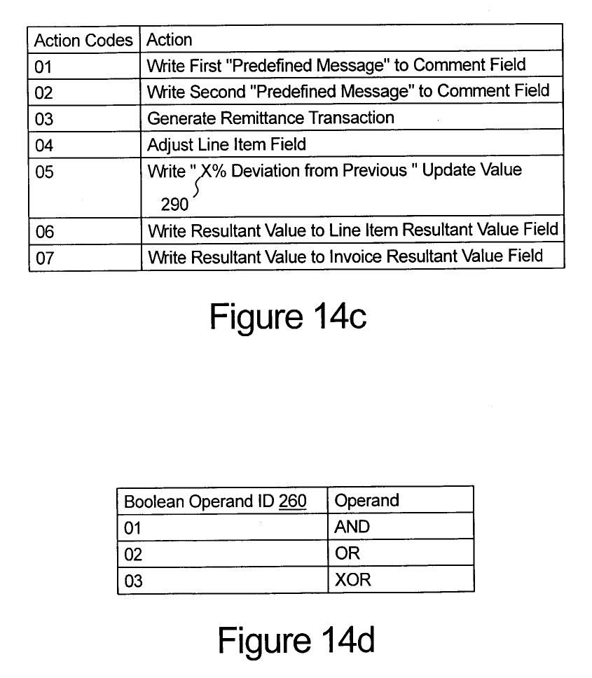

Turning briefly to FIG. 14a, the application code 221 may be a two digit code that identifies to which line items the rule applies. The exemplary codes 221 apply to such line items as follows: application code “01” indicates that the rule applies to all line items; application code “02” indicates that the rule applies to all line items for goods; application code “03” indicates that the rule applies to all line items for services; and application code “04” indicates that the rule applies to those line items with a description that matches “XYZ”.

Returning to FIG. 13 in conjunction with FIG. 5, the steps of group 228 represent steps that are preformed for each rule identified at step 226 that is a first rule in a Boolean string. The first rule key 240 in the rules table 71 is a single digit code that identifies those rules that are first in a Boolean string of rules.

Step 228 represents applying such rule to the line item to generate a result selected from the group of results consisting of true and false (referred to here in a generating a true or false result). More specifically, a rule value is compared to an invoice line item value using a mathematical operand to determine the true or false result.

The mathematical operand is identified by a mathematical operand ID 242 in the rules table 71. Turning briefly to FIG. 14b, the mathematical operand ID maybe a two digit code that identifies one of a plurality of mathematical operands. The exemplary codes 242 may be as follows: operand ID code “01” is a greater than operand; operand ID code “02” is a greater than or equal to operand; operand ID code “03” is a less than operand; operand ID code “04” is a less than or equal to operand; and operand ID code “05” is an equal to operand.

Returning to FIG. 13 in conjunction with FIG. 5, the two values to be compared may be numerical values or character values. As such, a value type ID field 242 is included in the rules table 71. The value type ID field may be a two digit code that identifies the value type. For example, code “01” may represent a numeric value and code “02” may represent a character value.

If the value type ID 244 indicates that the values to be compared are numeric, the numeric value in the numeric value field 248 is compared using the mathematical operand to the applicable numeric value of the line item. Alternatively, if the value type ID 244 indicates that the values to be compared are characters, the character value in the character value field 246 is compared using the mathematical operand to the applicable character string of the line item.

The identity of the field in the invoice line item (e.g. identify of the field in the line item table 31 of FIG. 3c) to which the value is to be compared is identified by a line item ID code 250 in the rules table 71. The line item code 250 may be a two digit code identifying one of the fields in the line item table 31 such as the gross item amount field, discount item amount field, net item amount field, units field, unit price field, ect.

Following determination of the true or false result of application of the rule at step 230, the evaluation engine 57 determines whether the rule is the last rule in a Boolean sequence of if there are additional rules at step 231. To enable the evaluation engine 57 to make such a determination, the rules table 71 includes a last rule key 252. The last rule key 252 may be a single digit code that indicates either that the rule is the last in a Boolean sequence or that there are additional rules in the Boolean sequence.

If the rule is the last rule at decision step 231, the evaluation engine executes the appropriate action based on the true or false result of the rule application at step 236. More specifically, the rules table 71 includes a true action code field 254 and a false action code field 256. The true action code field 254 may comprise a two digit code that corresponds to an action that the evaluation engine 57 takes in the event of a true result.

The table of FIG. 14c, represents some exemplary codes and actions. For example, code “01” may represent the evaluation engine writing a predefined message (that was established during rule configuration as discussed with reference to FIG. 8f) to the auto analysis comment field 258 of the line item record in the line item table 31 of FIG. 3c. For example, if a rule compares the line item price with a value that represents a pre-negotiated contract price, the predefined message may be “price in excess of contract price”. Code “02” may represent a different message such as “quantity in excess of standard”. Code of “03” may represent the evaluation automatically generating a remittance transaction on behalf of the payer and providing the remittance transaction to the session management engine 46 for writing to the transaction data tables 51. Code “04” may represent the evaluation engine automatically adjusting the value of one or more fields in the line item record of the line item table 31 and generating an email or transaction back to the vendors database system 26 indicated the adjustment. For example, the price field in the line item record may be adjusted to the contract price. Code “05” may represent writing a predefined message that includes a resultant value 290 to the auto analysis comment field 248 if the line item table of FIG. 3c or the auto analysis comment field 261 of the invoice summary table of FIG. 3b. (Writing the resultant value to the resultant value field 259 or field 263 will be discussed below). Code “05” may also include updating the value field 248 in the rules table 71 of FIG. 5. For example, the variable may be the percent deviation between the value field 248 and the units field of the line item table 31 of FIG. 3c. The message could be “Variable” deviation in units from previous invoice. It should be appreciated that because the value field is updated, the variable will always be variation from previous invoice.

Alternatively, if the rule is not the last rule at decision step 231, step 232 represent applying the next rule in the Boolean sequence. More specifically, the rules table 71 includes a Boolean rule number ID field 258 which includes a number that corresponds to the normalized rule number of the next rule in the Boolean sequence. Such rule is applied at step 232 and the result of applying such rule is combined with the result of applying the previous rule(s) using the Boolean operand as identified in the Boolean operand ID field 260.

Turning briefly to FIG. 14d, the Boolean operand ID 260 maybe a two digit code that identifies one of a plurality of Boolean operands. The exemplary codes may be as follows: operand ID code “01” is the Boolean operand “AND”; operand ID code “02” is the Boolean operand “OR”; and operand ID code “03” is the Boolean operand “XOR”.

Following the Boolean combination of the result of applying the next rule at step 232, step 230 is then performed. After all rules in the Boolean sequence are performed and the results combined, step 236 will be reached wherein the action as designated by the true action code 254 or the false action code 256 in the record for the last rule in the Boolean sequence will be performed.

Trending Analysis

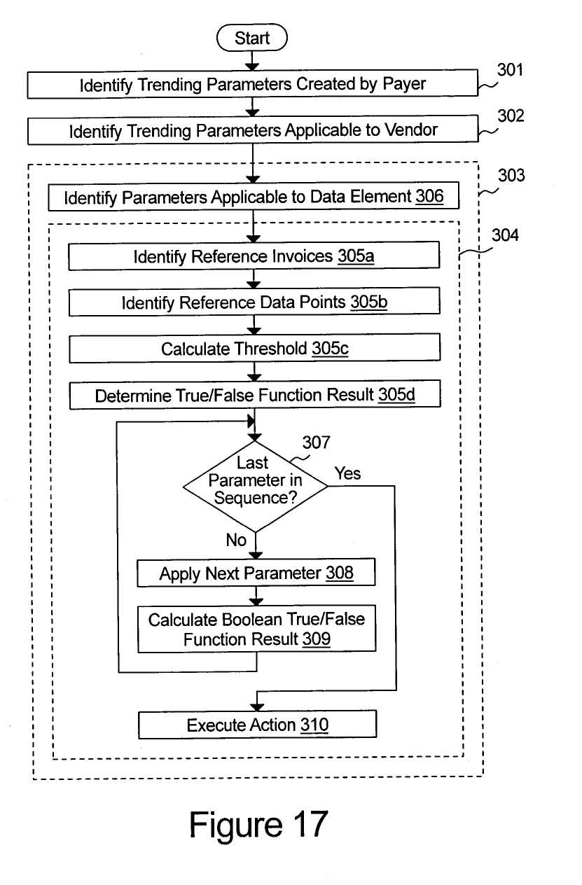

FIG. 16a represents an exemplary trending analysis table 302 and FIG. 17 represents exemplary operation of the evaluation engine 57 in performing a trending analysis when an invoice transaction has been loaded into the transaction data tables 51.

The trending analysis rules table 312 associates a plurality of trending analysis parameters that a customer may use to evaluate invoice data element values and invoice line item data element values on invoices provided by its vendors. The table 312 associates a unique normalized trending analysis number 314 to each analysis parameter set input by a payer in accordance with the systems discussed herein. Associated with the unique analysis are the client code of the vendor 21, the client code of the payer 23, an invoice data point type key 316, and line item data point type key 318, an evaluation type key 320, a transaction identifier key 322, a first parameter key 324, a last parameter key 326, a Boolean operand ID key 328, a Boolean analysis number 330, a true action code 332, and a false action code 334.

Referring to FIG. 17 in conjunction with FIG. 16a, step 301 represents identifying those trending parameters from the trending analysis table 312 that were created by the payer of the invoice transaction. This step may be performed by identifying those parameters that include the same client code of the payer 23 as the invoice transaction.

Step 302 represents identifying those trending parameters (from the set of parameters that has already been identified in step 301) that are applicable to the vendor of the invoice transaction. This step may be performed by identifying those parameters that include the same client code of the vendor 21 as the invoice transaction.

The steps of group 303 are then performed for each data element of the invoice transaction (including invoice level data elements and line item level data elements). Step 306 represents identifying those parameters that are applicable to the data element. This step may be accomplished by identifying those parameters (from those already identified at step 302) that include a data point type key 316 and a line item data point type key 318 that correspond to the data element.

Turning briefly to FIG. 16b, the invoice data point type key 316 may be a two digit code that identifies an invoice level data element to which the parameter applies. If the parameter applies to a line item level data element, the invoice data point type key 316 may be a particular key which so indicates. In the example, type key “01” indicates that the parameter applies to a line item level data element. The exemplary invoice data point type keys are as follows: type key “02” indicates that the parameter applies to the services gross amount data element; type key “03” indicates that the parameter applies to the services net amount data element; type key “04” indicates that the parameter applies to the goods gross amount data element; type key “05” indicates that the parameter applies to the goods net amount data element; type key “06” indicates that the parameter applies to the total gross amount data element; and type key “07” indicates that the parameter applies to the total net amount data element.

Turning briefly to FIG. 16c, the line item data point type key 318 may be a two digit code that identifies a line item level data element to which the parameter applies. If the parameter applies to an invoice level data element, the line item data point type key 318 may be a particular key which so indicates. In the example, type key “01” indicates that the parameter applies to an invoice level data element. The exemplary line item data point type keys are as follows: type key “02” indicates that the parameter applies to the gross item amount data element; type key “03” indicates that the parameter applies to the net item amount data element; type key “04” indicates that the parameter applies to the units data element; type key “05” indicates that the parameter applies to the unit price data element; and type key “06” indicates that the parameter applies to the percent complete data element.

Returning to FIG. 17, the steps of group 304 represent steps that are preformed for each parameter identified at step 306 that is a first parameter in a Boolean string of one or more parameters. The first parameter key 324 in the table 312 is a single digit code that identifies those parameters first in a Boolean string of parameters.

Step 305a represents identifying reference invoices for use in applying the parameter. More specifically, the transaction identifier key 322 may be used to identify reference invoices. Referring briefly to FIG. 16d, the transaction identifier key 322 may be a two digit code that identifies a group of invoices from which data points for may be extracted for performing the evaluation. In the example, identifier key “01” indicates that data points are within the one most recent invoice transactions; identifier key “02” indicates that the data points are within the two most recent invoice transactions; identifier key “03” indicates that the data points are within “x” most recent transactions; and identifier key “04” indicates that the data points are within the group of year-to-date invoices.

Returning to FIG. 17, step 305b represents identifying the reference data points. More specifically, the data points that correspond to the data point type (as determined by reference to the tables of FIG. 16b and FIG. 16c) and are within the reference invoices (as determined by reference to the table of FIG. 16d) are extracted from the database. For example, if the data element value is a line item “units” value, the data point type would be a line item “units” value for goods or services of the same description or other identifier.

Step 305c represents calculating a threshold which includes determining an evaluation type threshold and then calculating the threshold using the reference data points extracted in step 305b. The evaluation type key 320 may be used to identify the evaluation type threshold. Referring briefly to FIG. 16e, the evaluation type key 320 may be a two digit code that identifies a threshold for calculating a true false function result. For example, type key “01” indicates that the result of a true/false function is true if the data element is greater than the best fit line through the reference data points; type key “02” indicates that the result of a true/false function is true if the data element is greater than the average of the reference data points; type key “03” indicates that the result of a true/false function is true if the data element is greater than the mean of the reference data points. Returning to FIG. 17, step 305d represents determining the result of a true/false function.

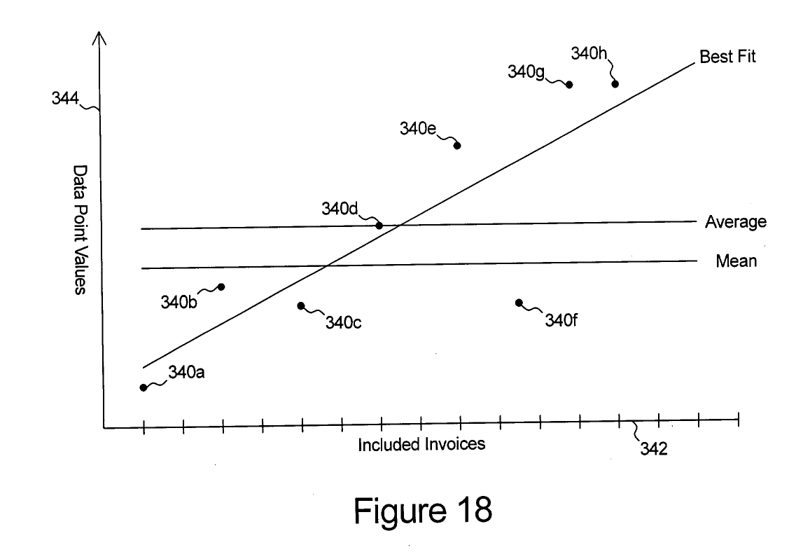

Turning briefly to FIG. 18, a graphical representation of evaluation is shown. Reference data points 340a-340h are plotted on the vertical coordinate 344 with the horizontal coordinate 342 representing another parameter such as the date of each invoice from which the data point was extracted. A best fit line, an average, a mean, or other evaluation function may then be determined.

Returning to FIG. 17, step 307 represents determining whether the parameter is the last parameter in a Boolean sequence. The last parameter key 326 may be a single digit code that indicates either that the parameter is the last in a Boolean sequence or that there are additional parameters in the Boolean sequence.

If the parameter is the last parameter at decision step 307, the evaluation engine executes the appropriate action based on the true or false result of the rule application at step 310. More specifically, the trending analysis table 312 includes a true action code field 332 and a false action code field 334. The true action code field 332 may comprise a two digit code that corresponds to an action that the evaluation engine 57 takes in the event of a true result and the false action code field 332 may comprise a two digit code that corresponds to an action that the valuation engine 57 takes in the event of a false result. Again, the table of FIG. 14c, represents some exemplary codes and actions.

Alternatively, if the parameter is not the last parameter at decision step 307, step 308 represent applying the next parameter in the Boolean sequence. More specifically, the analysis table 312 includes a Boolean analysis number field 330 which includes a number that corresponds to the normalized trending analysis number of the next parameter in the Boolean sequence. Such parameter is applied at step 308 by using each of the steps previously discussed with reference to steps 305a through 305d and the result of applying such parameter is combined with the result of applying the previous parameter(s) using the Boolean operand as identified in the Boolean operand ID field 328 and with reference to the table of FIG. 14d.

Following the Boolean combination of the result of applying the next parameter at step 309, step 307 is again performed. After all parameters in the Boolean sequence are performed and the results combined, step 310 will be reached wherein the action as designated by the true action code 332 or the false action code 334 in the record for the last parameter in the Boolean sequence will be performed.

Quantitative Evaluation

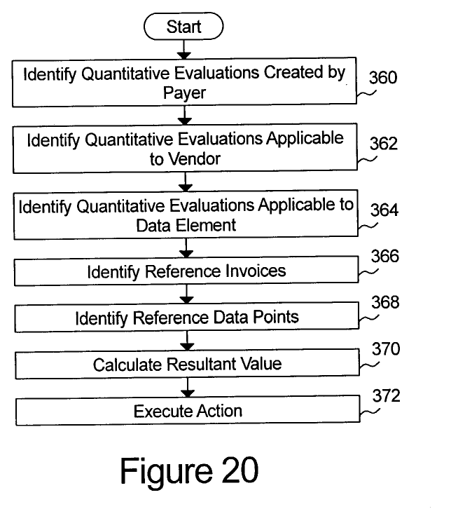

FIG. 19a represents an exemplary quantitative evaluation table 350 and FIG. 20 represents exemplary operation of the evaluation engine 57 in performing a quantitative evaluation when an invoice transaction has been loaded into the transaction data tables 51 and writing a resultant value 290 to one of the invoice summary table resultant value field 263 (FIG. 3b) or the line item resultant value field 259 (FIG. 3c).

The quantitative evaluation table 350 associates a plurality of quantitative evaluation functions that a customer may use to evaluate invoice value and invoice line item values on invoices provided by its vendors. The table 350 associates a unique normalized quantitative evaluation number 352 to each function entered by a payer in accordance with the systems discussed herein. Associated with the unique evaluation number 352 are the client code of the vendor 21, the client code of the payer 23, the invoice data point type key 316, the line item data point type key 318, the transaction identifier key 322, a quantitative evaluation function key 354, and an action code 355.

Referring to FIG. 20 in conjunction with FIG. 19a, step 360 represents identifying those quantitative evaluations from the quantitative evaluation table 250 that were created by the payer of the invoice transaction. This step may be performed by identifying those evaluations that include the same client code of the payer 23 as the invoice transaction.

Step 362 represents identifying those evaluations (from the set of evaluations that has already been identified in step 360) that are applicable to the vendor of the invoice transaction. This step may be performed by identifying those evaluations that include the same client code of the vendor 21 as the invoice transaction.

Step 364 represents identifying those evaluations that are applicable to the data element. This step may be accomplished by identifying those evaluations (from those already identified at step 362) that include a data point type key 316 (as discussed with reference to FIG. 16b) and a line item data point type key 318 (as discussed with reference to FIG. 16c) that correspond to the data element.

Step 366 represents identifying reference invoices for performing the evaluation. More specifically, the transaction identifier key 322 may be used to identify the reference invoices as discussed with referenced to FIG. 16d.

Step 368 identifying the reference data points. More specifically, the data points that correspond to the data point type (as determined by reference to the tables of FIG. 16b and FIG. 16c) and are within the reference invoices (as determined by reference to the table of FIG. 16d) are extracted from the database.

Step 370 represents performing the quantitative evaluation which includes determining the quantitative evaluation function and applying the function to the reference data points and to the data element to determine the resultant value 290.

The quantitative evaluation function key 354 may be used to identify the evaluation function. Referring briefly to FIG. 19a, the evaluation function key 354 may be a two digit code that identifies a function. For example, type key “01” indicates a function that is the average of the reference data points and the data element; type key “02” indicates a function that is the mean of the reference data points and the data element; type key “03” indicates a function that is the percent increase of the data element value over the average of the data points; type key “04” indicates a function that is the percent deviation of the data element value from the best fit line through the data points; and type key “05” indicates a function that is the total sum of the data points plus the data element.

Step 372 represents the evaluation engine executing the appropriate action based on the action code in field 355. In the exemplary embodiement, action code “06” as depicted in the action code table of FIG. 14c may represent writing the resultant value 290 to the resultant value field 259 of the line item table of FIG. 3c. And, action code “07” may represent writing the resultant value to the resultant value field 263 of the invoice summary table of FIG. 3b.

Summary

In summary, the present invention provides for automated analysis of transaction data elements based on rules, automated trending analysis based on evaluation parameters, and automated quantitative analysis based on evaluation functions. All such rules, evaluation parameters, and evaluation functions may be established by the payer to apply to all transactions, or to transactions only from certain vendors.

Although the invention has been shown and described with respect to certain preferred embodiments, it is obvious that equivalents and modifications will occur to others skilled in the art upon the reading and understanding of the specification. It is envisioned that after reading and understanding the present invention those skilled in the art may envision other processing states, events, and processing steps to further the objectives of the modular multi-media communication management system of the present invention. The present invention includes all such equivalents and modifications, and is limited only by the scope of the following claims.

What is claimed is:

1. An electronic transaction processing server for exchanging electronic transaction files between a plurality of participating systems, the server comprising:
a database for storing data representative of a plurality of transactions between the participating systems;
a network circuit for communicating over a frame switched network with each of the plurality of participating systems;
a transaction management engine comprising:
means for establishing a secure session with each of a receiving system and a first participating system through the network circuit;
means for receiving a first evaluation parameter set from the receiving system, the first evaluation parameter set comprising:
identification of a first plurality of reference transactions stored in the database;
identification of at least one data point value within each of the first plurality of reference transactions;
identification of a first evaluation threshold function;
means for receiving an import electronic transaction file from the first participating system, the import transaction file comprising a plurality of transaction data element values in a file format that complies with a first import file definition and including at least one transaction data element value that is a first key element value;
means for providing an export electronic transaction file to the receiving system, the export electronic transaction file comprising the plurality of data element values in a file format that complies with a receiving system file definition and comprises an evaluation message;
an evaluation engine for selecting one of a plurality of evaluation messages by:
calculating a first threshold value by applying the first threshold evaluation function to each data point value from each of the first plurality of reference transactions;
determining a first true/false result by comparing the first key element value to the first threshold value;
selecting the one of the plurality of evaluation messages the corresponds to the first true/false function result.

2. The server of claim 1, wherein the transaction management engine further comprises means for storing the evaluation parameter set in a database.

3. The server of claim 2, wherein the transaction management engine further comprises:
a translation engine comprising:
means for translating the plurality of data element values of the import electronic transaction file to a plurality of normalized data element values complying with a normalized file definition;
means for storing the plurality of normalized data element values in a transaction database; and
means for generating at least a portion of the export electronic transaction file by translating the plurality of normalized data element values to a plurality of export data element values complying with the receiving system file definition.

4. The server of claim 3, wherein the evaluation engine further provides for writing a an indication of the selected one of the plurality of predefined messages to the database.

5. The server of claim 4, wherein:
wherein the message comprises a resultant value;
the transaction management engine further comprises means for receiving a quantitative evaluation function; and
the evaluation engine further comprises means for calculating a resultant value by calculating the result of applying the quantitative evaluation function to each data point value from each of the plurality of reference transactions.

6. The server of claim 1, wherein:
the transaction management engine further comprises:
means for receiving a second evaluation parameter set from the receiving system and a Boolean operator for relating the first true/false function result to a second true/false function result; the second evaluation parameter set comprising:
identification of a second plurality of reference transactions stored in the database;
identification of at least one data point value within each of the second plurality of reference transactions;
identification of a second evaluation threshold function; and
the evaluation engine further comprises:
means for calculating the result of applying the second evaluation parameter to the second key element value by:
calculating a second threshold value by applying the second threshold evaluation function to each data point value from each of the second plurality of reference transactions;
determining a second true/false result by comparing the second key element value to the second threshold value;
determining a Boolean true/false result by comparing, using the Boolean operator, the first true/false function result to the second true/false function result; and
the step of selecting one of the plurality of evaluation messages comprises selecting the one of the plurality of evaluation messages that corresponds to the Boolean true/false result.

7. The server of claim 6, wherein the transaction management engine further comprises means for storing the evaluation parameter set in a database.

8. The server of claim 7, wherein the transaction management engine further comprises:
a translation engine comprising:
means for translating the plurality of data element values of the import electronic transaction file to a plurality of normalized data element values complying with a normalized file definition;
means for storing the plurality of normalized data element values in a transaction database; and
means for generating at least a portion of the export electronic transaction file by translating the plurality of normalized data element values to a plurality of export data element values complying with the receiving system file definition.

9. The server of claim 8, wherein the evaluation engine further provides for writing a an indication of the selected one of the plurality of predefined messages to the database.

10. The server of claim 9, wherein:
wherein the message comprises a resultant value;
the transaction management engine further comprises means for receiving a quantitative evaluation function; and
the evaluation engine further comprises means for calculating a resultant value by calculating the result of applying the quantitative evaluation function to each data point value from each of the plurality of reference transactions.

11. A method of processing electronic transactions between a plurality of participating systems, the method comprising:
establishing a secure session with a receiving system over a frame switched network;
establishing a secure session with a first participating system over a frame switched network;
receiving a first evaluation parameter set from the receiving system, the first evaluation parameter set comprising:
identification of a first plurality of reference transactions stored in a database;
identification of at least one data point value within each of the first plurality of reference transactions;
identification of a first evaluation threshold function;
receiving an import electronic transaction file from the first participating system, the import transaction file comprising a plurality of transaction data element values in a file format that complies with a first import file definition and at least one of the transaction data element values being a first key element value;
calculating a first threshold value by applying the first threshold evaluation function to each data point value from each of the first plurality of reference transactions;
determining a first true/false result by comparing the first key element value to the first threshold value;
selecting an evaluation message from one of a plurality of evaluation messages the corresponds to the first true/false function result;
providing an export electronic transaction file to the receiving system, the export electronic transaction file comprising the plurality of transaction data element values in a file format that complies with a receiving system file definition and comprises the evaluation message.

12. The method of claim 11, further comprising storing the evaluation parameter set in a database.

13. The method of claim 12, further comprising:
translating the plurality of data element values of the import electronic transaction file to a plurality of normalized data element values complying with a normalized file definition;
storing the plurality of normalized data element values in a transaction database; and
generating at least a portion of the export electronic transaction file by translating the plurality of normalized data element values to a plurality of export data element values complying with the receiving system file definition.

14. The method of claim 13, further comprising:
writing an indication of the selected evaluation message to the database.

15. The method of claim 14, wherein:
wherein the message comprises a resultant value; and the method further comprises:
receiving a quantitative evaluation function; and
calculating a resultant value by calculating the result of applying the quantitative evaluation function to each data point value from each of the plurality of reference transactions.

16. The method of claim 11, further comprising:
receiving a second evaluation parameter set and a Boolean operator from the receiving system, the Boolean operator for relating the first true/false function result to a second true/false function result; the second evaluation parameter set comprising:
identification of a second plurality of reference transactions stored in the database;
identification of at least one data point value within each of the second plurality of reference transactions;
identification of a second evaluation threshold function; and
the evaluation engine further comprises:
calculating the result of applying the second evaluation parameter to the second key element value by:
calculating a second threshold value by applying the second threshold evaluation function to each data point value from each of the second plurality of reference transactions;
determining a second true/false result by comparing the second key element value to the second threshold value;
determining a Boolean true/false result by comparing, using the Boolean operator, the first true/false function result to the second true/false function result; and
the step of selecting one of the plurality of evaluation messages comprises selecting the one of the plurality of evaluation messages that corresponds to the Boolean true/false result.

17. The method of claim 16, further comprising storing the evaluation parameter set in a database.

18. The method of claim 17, further comprising:
translating the plurality of data element values of the import electronic transaction file to a plurality of normalized data element values complying with a normalized file definition;
storing the plurality of normalized data element values in a transaction database; and
generating at least a portion of the export electronic transaction file by translating the plurality of normalized data element values to a plurality of export data element values complying with the receiving system file definition.

19. The method of claim 18, further comprising writing the selected evaluation message to the database.

20. The method of claim 19, wherein the message comprises a resultant value; and the method further comprises:
receiving a quantitative evaluation function; and
calculating the result of applying the quantitative evaluation function to each data point value from each of the plurality of reference transactions.
